(19) United States
(12) Patent Application Publication
(10) Pub. No.: US 2024/0383370 A1
(43) Pub. Date: Nov. 21, 2024

(54) Battery-Storage Apparatus and Battery-Exchange System

(71) Applicant: Ample, Inc., San Francisco, CA (US)

(72) Inventors: Maxim Zolotarev, San Francisco, CA (US); Alexander Craig Kundrot, San Francisco, CA (US); Kenji Bowers, San Francisco, CA (US)

(21) Appl. No.: 18/666,365

(22) Filed: May 16, 2024

Related U.S. Application Data
(60) Provisional application No. 63/502,432, filed on May 16, 2023.

(51) Int. Cl. B60L 53/80; B65G 1/04; E04H 5/06; H01M 50/204; H01M 50/244; H01M 50/249; H01M 50/284

(52) U.S. Cl. CPC B60L 53/80; B65G 1/0435; H01M 50/204; H01M 50/244; H01M 50/249; H01M 50/284; E04H 5/06; H01M 2220/20

(57) ABSTRACT

A battery-storage apparatus includes a plurality of cubbies having respective electrical ports, a tray bay having an adjustable frame that releasably holds a battery tray, and a robotic crane that transports batteries between the battery tray and respective cubbies to charge and/or discharge the batteries using the respective electrical ports. The battery tray can be transported to and from the tray bay by a battery-exchange robot.

### CROSS-REFERENCE TO RELATED APPLICATIONS

This application claims priority to U.S. Provisional Application No. 63/502,432, titled “Battery-Storage Apparatus and Battery-Exchange System,” filed on May 16, 2023, which is hereby incorporated by reference.

### TECHNICAL FIELD

This application relates generally to battery-exchange systems for electric vehicles.

### BACKGROUND

Electric vehicles have limited range and battery life and periodically need additional electrical energy. When the electric-vehicle batteries are low or depleted, they are traditionally recharged by physically coupling an electrical charger to a charge port on the vehicle. Even with rapid charging, it takes at least 30 minutes to partially recharge the batteries. Another approach is to exchange the depleted batteries with charged batteries. Battery swapping can be performed in minutes, but additional infrastructure and technology are needed.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

An aspect of the invention is directed to a battery-storage apparatus comprising a plurality of cubbies having respective electrical ports; a tray bay having an adjustable frame that releasably holds a battery tray; and a robotic crane that transports batteries between the battery tray and respective cubbies to charge and/or discharge the batteries using the respective electrical ports.

In one or more embodiments, each cubby includes a floor, sidewalls, a rear wall, a ceiling, and an open end. In one or more embodiments, the open end of each cubby is aligned with respect to a first axis. In one or more embodiments, a respective printed circuit board (PCB) is mounted on a surface of each cubby, each electrical port mounted on the respective PCB.

In one or more embodiments, each PCB includes one or more alignment pins. In one or more embodiments, a respective support frame is attached to the surface of each cubby, each PCB mounted on the respective support frame, and the respective support frame includes flexible spirals that allow the respective PCB to translate parallel to the surface of each cubby.

In one or more embodiments, the tray bay includes a frame that is defined, at least in part, by a pair of robotic arms, the robotic arms configured to move inwardly to hold the battery tray and to move outward to release the battery tray. In one or more embodiments, the crane includes a shaft that extends along a vertical axis; a base attached to the shaft; a telescoping arm attached to the base; and robotic grippers attached to the telescoping arm, the robotic grippers configured to releasably hold an individual battery. In one or more embodiments, the base is electromechanically attached to the shaft such that a height of the base is adjustable. In one or more embodiments, the telescoping arm is configured to extend and retract with respect to a first axis, and an open end of each cubby is aligned with respect to the first axis.

In one or more embodiments, the robotic grippers includes fingers having planar surfaces to mechanically engage the individual battery. In one or more embodiments, a first set of the fingers is mechanically attached to a first robotic arm, a second set of the fingers is mechanically attached to a second robotic arm, the first and second robotic arms are configured to move inwardly such that the first and second set of fingers mechanically engage first and second sides, respectively, of the individual battery, and the first and second robotic arms are configured to move outwardly such that the first and second set of fingers release the first and second sides, respectively, of the individual battery.

In one or more embodiments, the apparatus further comprises one or more tracks that extend parallel to a second axis that is orthogonal to the first and vertical axes, wherein the shaft is mounted on the one or more tracks to adjust a position of the shaft with respect to the second axis. In one or more embodiments, a battery-exchange robot channel is defined below the tray bay, the battery-exchange robot channel configured to receive rails on which a battery-exchange robot is mounted.

Another aspect of the invention is directed to a battery-storage apparatus comprising a plurality of cubbies having respective electrical ports; a plurality of tray bays, each tray bay having a respective adjustable frame configured to releasably hold a respective battery tray, each battery tray holding one or more batteries; and a plurality of robotic cranes, each robotic crane configured to transport the battery(ies) between the respective battery tray and respective cubbies to charge and/or discharge the batteries using the respective electrical ports.

In one or more embodiments, each crane includes a shaft that extends parallel to a vertical axis; a base electromechanically attached to the shaft such that a height of the base is adjustable; a telescoping arm attached to the base; and robotic grippers attached to the telescoping arm, the robotic grippers including fingers having planar surfaces to releasably hold an individual battery. In one or more embodiments, for each crane the telescoping arm is configured to extend and retract with respect to a first axis, and an open end of each cubby is aligned with respect to the first axis.

In one or more embodiments, for each crane a first set of the fingers is mechanically attached to a first robotic arm, a second set of the fingers is mechanically attached to a second robotic arm, the first and second robotic arms are configured to move inwardly such that the first and second set of fingers mechanically engage first and second sides, respectively, of the individual battery, and the first and second robotic arms are configured to move outwardly such that the first and second set of fingers release the first and second sides, respectively, of the individual battery.

In one or more embodiments, the apparatus further comprises one or more common tracks that extend parallel to a second axis that is orthogonal to the first and vertical axes, wherein a respective shaft of each crane is mounted on the one or more common tracks to adjust a position of the respective shaft with respect to the second axis.

Another aspect of the invention is directed to a battery-exchange system comprising a battery-exchange robot configured to transport a battery tray between an electric vehicle and a battery-storage apparatus. The battery-storage apparatus comprises a plurality of cubbies having respective electrical ports; a tray bay having an adjustable frame that releasably holds the battery tray, wherein a battery-exchange robot channel is defined below the tray bay; and a robotic crane that transports batteries between the battery tray and respective cubbies to charge and/or discharge the batteries using the respective electrical ports.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a front view of an electric-vehicle service station according to an embodiment.

FIG. 2 is an isometric view of a battery-storage apparatus according to an embodiment.

FIG. 3 is a detailed view of the battery-storage apparatus illustrated in FIG. 2.

FIG. 4 is an isolated isometric view of the tray bays illustrated in FIG. 2.

FIG. 5 is an isolated isometric view of one of the cranes illustrated in FIG. 2.

FIG. 6 is an isometric cross-sectional view of the battery-storage apparatus illustrated in FIG. 2 when the robotic grippers are contracted.

FIG. 7 is a detailed view of the crane illustrated in FIG. 6.

FIG. 8 is a detailed view of an example cubby illustrated in FIG. 6.

FIG. 9 is an isolated front view of a printed circuit board in the example cubby illustrated in FIG. 8.

FIG. 10 is an isometric cross-sectional view of the battery-storage apparatus illustrated in FIG. 2 when the robotic grippers extended.

FIG. 11 is a detailed view of the crane illustrated in FIG. 10.

FIG. 12 is a front view of the battery-storage apparatus with a maintenance crane.

FIG. 13 is an isometric view of the battery-storage apparatus illustrated in FIG. 12.

FIG. 14 is a flow chart of a method for adding batteries to a battery-storage apparatus.

FIG. 15 is a flow chart of a method for removing batteries from a battery-storage apparatus.

FIG. 16 is an isometric view of the battery-exchange system where the battery-exchange robot is disposed outside the battery-exchange robot channel.

FIG. 17 is an isometric view of the battery-exchange system where the battery-exchange robot is disposed in the battery-exchange robot channel and the motorized lift is in a lowered state.

FIG. 18 is an isometric view of the battery-exchange system where the battery-exchange robot is disposed in the battery-exchange robot channel and the motorized lift is in a raised state.

FIG. 19 is an isolated isometric view of the battery-exchange robot when a motorized battery lift is in a raised position

FIG. 20 is an isometric view of the battery-exchange system where robotic clamps are holding the battery tray in the tray bay.

FIG. 21 is an isometric view of the battery-exchange system where the crane is positioned to pick up a battery from the battery tray in the tray bay.

FIG. 22 is an isometric view of the battery-exchange system where the crane has picked up a battery from the battery tray in the tray bay and is placing the battery in a cubby for charging.

FIG. 23 is an isolated isometric rear view of crane assembly to illustrate the drive assemblies for the cranes according to an embodiment.

FIG. 24 is an isolated rear view of the crane assembly according to an embodiment.

FIG. 25 is an isolated isometric front view of the crane assembly according to an embodiment.

FIG. 26 is an isolated top view of the crane assembly according to an embodiment.

FIG. 27 is a cross section through the isolated top view shown in FIG. 26 according to an embodiment.

FIG. 28 is an isometric view of the end effector assembly according to an embodiment.

FIG. 29 is a detailed view of the moveable assembly shown in FIG. 28 to further illustrate the rotational drive assembly according to an embodiment.

FIG. 30 is a top view of the end effector assembly according to an embodiment.

FIG. 31 is a cross section of the end effector assembly according to an embodiment.

FIG. 32 is another cross section of the end effector assembly according to an embodiment.

FIG. 33 is an isometric view of the lower assembly in an unlocked state according to an embodiment.

FIG. 34 is an isometric view of the lower assembly in a locked state according to an embodiment.

FIGS. 35A and 35B are lower isometric views of the lower assembly where the latches are in unlocked and locked states, respectively, according to an embodiment.

FIGS. 36A and 36B are top views of the lower assembly where the latches are in unlocked and locked states, respectively, according to an embodiment.

FIG. 37 is an isometric view of a tray bay assembly according to an embodiment.

FIG. 38 is a first cross section through the tray bay assembly illustrated in FIG. 37 according to an embodiment.

FIG. 39 is a second cross section through the tray bay assembly illustrated in FIG. 37 according to an embodiment.

### DETAILED DESCRIPTION

A battery-storage apparatus is provided for storing and charging electric-vehicle (EV) batteries. The battery-storage apparatus includes a plurality of cubbies that can be arranged in columns and/or rows. Each cubby includes a high-voltage electrical port that forms an electrical connection with an EV battery when is placed in a respective cubby. The electrical connection can be used to discharge and/or charge the EV battery. For example, the EV battery can be discharged when the unit price of electricity is high (e.g., at a peak time) and/or can be charged when the unit price of electricity is low (e.g., at an off-peak time).

The battery-storage apparatus includes one or more cranes that are configured to transport individual batteries between a battery tray on a tray bay and the cubbies. Each crane includes robotic grippers that are mounted on a telescoping arm that can extend and retract with respect to a first axis. The telescoping arm is attached to a base that can be raised and lower along a vertical shaft. The shaft is mounted on one or more rails to position the shaft with respect to a second axis that is orthogonal to the first axis and to a vertical axis.

The battery-storage apparatus includes one or more tray bays that includes robotic arms that can releasably secure a respective battery tray. The battery tray can be lifted from a battery-exchange robot to one of the tray bays to secure the battery tray. In addition, the tray bay can release the battery tray and the battery-exchange robot can lower the battery tray.

The battery-exchange robot can transport a battery tray with one or more depleted charged batteries from an EV (e.g., on a vehicle lift) to one of the tray bays in the battery-storage apparatus to be charged in a respective one or cubbies. In addition, the battery-exchange robot can transport a battery tray with one or more charged batteries from one of the tray bays to an EV (e.g., on a vehicle lift), in a battery exchange or battery swap.

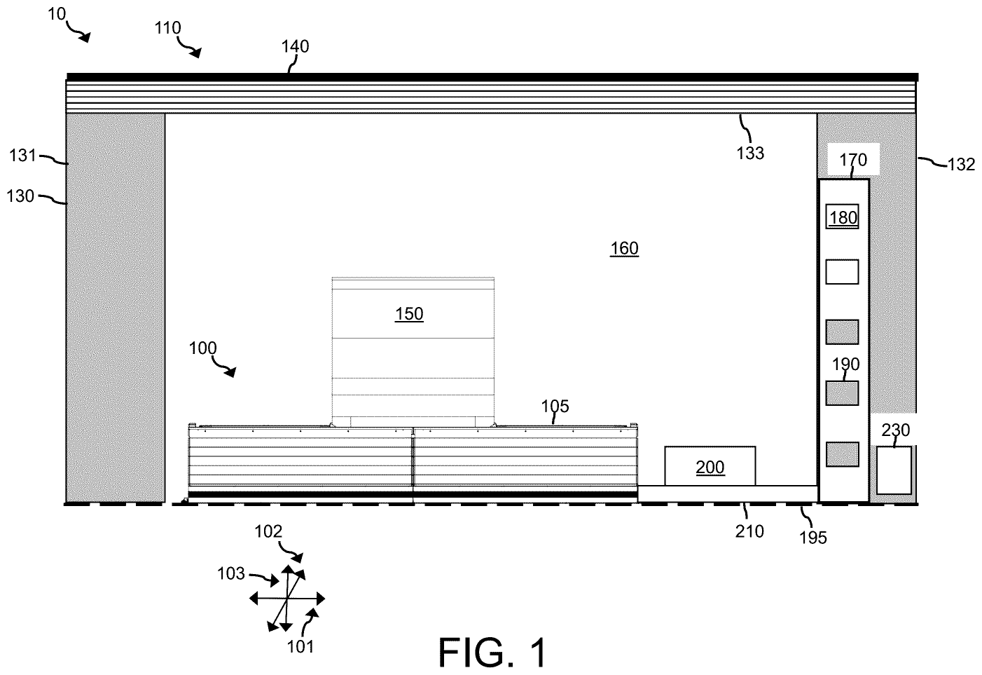

FIG. 1 is a front view of an electric-vehicle service station 10 according to an embodiment. The service station 10 can be transportable and can be placed on the ground or another surface 195.

The service station 10 includes a vehicle lift 100 and, optionally, an at least partially enclosed structure 110. The vehicle lift 100 includes a platform 105 that is configured to lift an electric vehicle 150. When the electric vehicle 150 is lifted, a service cavity is formed beneath the platform 105, such as between the ground 195 and the platform 105, in which a battery-exchange robot 200 can maneuver to receive one or more depleted batteries and/or to provide one or more charged batteries. The vehicle lift 100 can be the same as described in U.S. patent application Ser. No. 18/317,985, titled “Configurable Vehicle Lift and Service Station,” filed on May 16, 2023, which is hereby incorporated by reference. The battery-exchange robot 200 can be the same as described in U.S. patent application Ser. No. 18/318,001, titled “Battery-Exchange System and Service Station,” filed on May 16, 2023, which is hereby incorporated by reference.

The structure 110 includes a plurality of walls 130 and a roof 140. The walls 130 include at least first and second sidewalls 131, 132 that extend along the length of the vehicle lift 100 and along or parallel to the second axis 102. The roof 140 extends over the vehicle lift 100 and covers the vehicle lift 100 along its length and width (e.g., with respect to first and second axes 101, 102, respectively). The height of the roof 140, as measured with respect to a third axis 103, is set to allow the vehicle lift 100 to be in a raised state without the electric vehicle 150 contacting the roof 140. The height of the roof 140 can be configured to accommodate a wide range of vehicles including sedans, large delivery vans, and other vehicles. The roof 140 is configured to block rain, snow, and/or debris from passing into a service-station cavity 160 defined by and within the structure 110. The roof 140 can also block the sun to reduce the temperature in the service cavity 160.

The battery-exchange robot 200 can move along rails 210 between the vehicle lift 100 and a battery-storage apparatus 170. For example, the battery-exchange robot 200 can receive one or more discharged batteries 180 (e.g., in one or more battery trays) from the underside of the vehicle 150, transport the discharged battery(ies) 180 to the battery-storage apparatus 170, and place the discharged battery(ies) 180 in the battery-storage apparatus 170 to be charged. Additionally or alternatively, the battery-exchange robot 200 can receive one or more charged batteries 190 that are removed from the battery-storage apparatus 170, transport the charged battery(ies) 190 (e.g., in one or more battery trays) into the service cavity of the vehicle lift 100, and lift the charged battery(ies) to the underside of the vehicle 150 to attach the charged battery(ies) and/or battery tray(s) thereto. The rails 210 extend along and/or parallel to the first axis 101. Axes 101-103 are mutually orthogonal.

The battery-storage apparatus 170 is at least partially defined in the second sidewall 132. In an alternative embodiment, the battery-storage apparatus 170 can be at least partially defined in the first sidewall 131.

In some embodiments, the walls 130 include retractable doors 133. The retractable doors 133 can be opened to allow the vehicle 150 to drive onto or off of the vehicle lift 100, similar to an automatic garage door. The retractable doors 133 can be closed after the vehicle 150 drives onto the vehicle lift 100 or when the service station 100 is not in use (e.g., between vehicles, when the service station 100 is closed or offline, etc.). The retractable door 133 illustrated is a front door. The other retractable door 133, the back door, of the structure 110 can be the same as the front door and is not illustrated for brevity.

The electric-vehicle service station 10 includes one or more computer(s) and/or controllers 230 (in general, controller 230). The controller 230 is communication (e.g., wired and/or wireless communication) with the vehicle lift 100, the retractable doors 133, the battery-storage apparatus 170, and the battery-exchange robot 200. The controller 230 includes one or more processors that is/are operably coupled to non-transitory and/or non-volatile memory that stores computer-readable instructions (e.g., software) configured to be executed by the processor(s) to perform one or more tasks as described herein.

The controller 230 is configured to send control signals to the vehicle lift 100, to the retractable doors 133, to the battery-storage apparatus 170, and/or to the battery-exchange robot 200 (in general, components). The control signals can cause each component to perform one or more tasks, operations, and/or movements. For example, the control signals can cause the vehicle lift 100 to lift or lower the electric vehicle 150. In another example, the control signals can cause the retractable doors 133 to open or shut. In another example, the control signals can cause the battery-storage apparatus 170 to transfer a discharged battery 180 from the battery-exchange robot 200 (and from the electric vehicle 150) to an appropriate location (e.g., cubby) to be charged or to transfer a charged battery 190 from a given location (e.g., cubby) to the battery-exchange robot 200 to be secured to the electric vehicle 150. In another example, the control signals can cause the battery-exchange robot 200 to receive a discharged battery 180 from the electric vehicle 150 and bring the discharged battery 180 to the battery-storage apparatus 170 or to receive a charged battery 190 from the battery-storage apparatus 170 and bring the charged battery 190 to the electric vehicle 150.

The controller 230 can receive data, acknowledgements, and/or signals (in general, signals) from the vehicle lift 100, from the retractable doors 133, from the battery-storage apparatus 170, and/or from the battery-exchange robot 200. The signals can be received in response to the control signals (e.g., as an acknowledgment), after a task is completed, and/or at other times for example regarding the state, position, and/or configuration of the respective component.

In some embodiments, the controller 230 can be in communication (e.g., wired and/or wireless communication) with the electric vehicle 150. For example, the controller 230 can send control signals that cause the electric vehicle 150 to be placed in park and/or to confirm that the electric vehicle 150 is in park, for example before sending control signals that cause the vehicle lift 100 to be raised. The control signals can also be used to determine the state (e.g., the charge state) of each battery or battery module in the electric vehicle 150. The control signals can also be used to cause the electric vehicle 150 to release a discharged battery 180 when the battery-exchange robot 200 is positioned to receive the discharged battery 180. The control signals can also be used to cause the electric vehicle 150 to secure a charged battery 190 when the battery-exchange robot 200 is positioned to lift the charged battery 190 into vehicle 150. For example, the electric vehicle 150 can loosen or tighten one or more bolts to release or secure, respectively, a battery from the underside of the vehicle 150.

In some embodiments, the controller 230 can send control signals to an autonomous electric vehicle that causes the autonomous electric vehicle to drive to a target position on the vehicle lift 100, to place the autonomous electric vehicle in park when the autonomous electric vehicle is positioned at the target position, to release discharged battery(ies) 180 from autonomous electric vehicle, and/or to secure charged battery(ies) 190 to the autonomous electric vehicle.

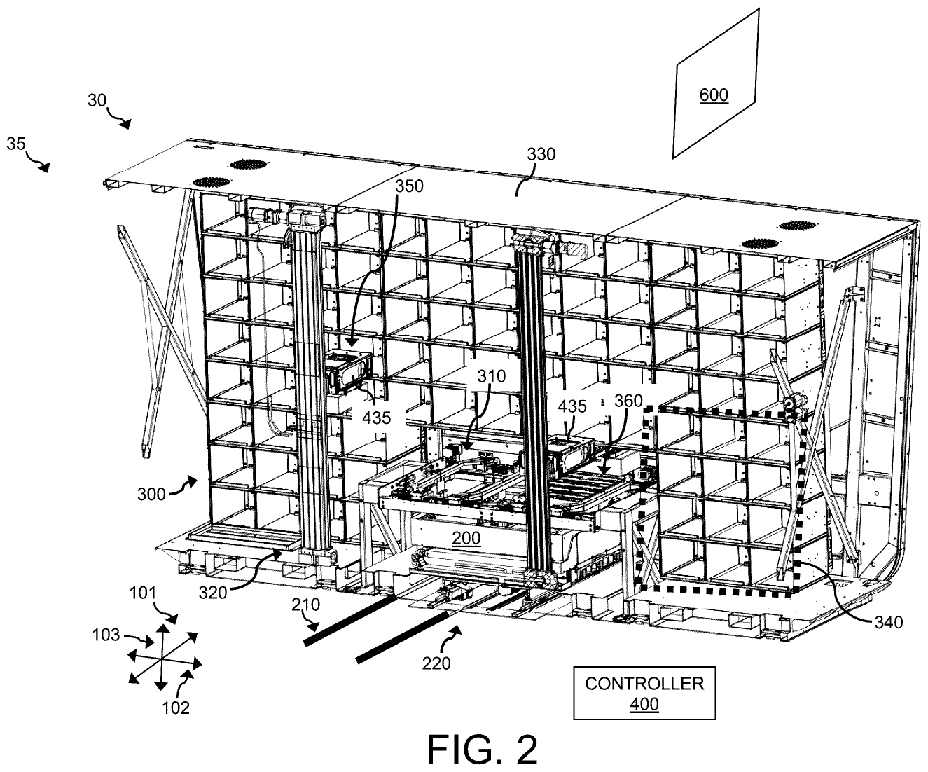

FIG. 2 is an isometric view of a battery-storage apparatus 30 according to an embodiment. The battery-storage apparatus 30 can be the same as battery-storage apparatus 170. The rails 210 can extend to the battery-storage apparatus 30 to allow the battery-exchange robot 200 to travel between the battery-storage apparatus 30 and the vehicle lift 100. The rails 210 can extend into a battery-exchange robot channel 220 defined in the battery-storage apparatus 30. The rails 210 can extend through the battery-exchange robot channel 220 to another vehicle lift such that the battery-storage apparatus 30 is shared with two vehicle lifts. The battery-exchange robot channel 220 is located and/or defined below tray bays 310. The battery-storage apparatus 30, the rails 210, and the battery-exchange robot 200 can comprise a battery-exchange system 35. The rails 210 can be optional in some embodiments.

The battery-storage apparatus 30 includes cubbies 300, tray bays 310, and cranes 320. Each cubby 300 is sized to receive and hold a respective battery or a respective battery module (in general, battery) during charging and/or for storage. The cubbies 300 are arranged in an array or grid of columns and rows. The cubbies 300 can have a different arrangement in other embodiments. The cubbies 300 can be defined in and/or supported by a housing 330. The housing 330 also supports the cranes 320 but that portion of the housing 330 is removed to not obscure the cranes 320. Two cranes 320 are illustrated but in other embodiments, there can be a different number of cranes 320 such as one crane 320 or three or more cranes 320.

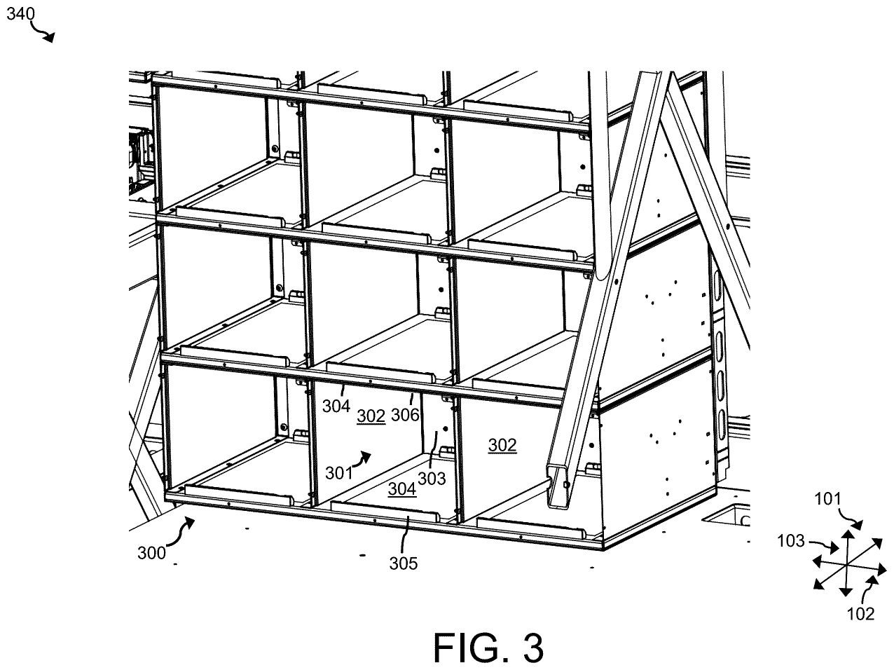

Each cubby 300 has an open end 301 and a structure that includes a pair of sidewalls 302, a rear wall 303, and a floor 304, as illustrated in FIG. 3 which shows a detailed view of region 340 of the battery-storage apparatus 30 in FIG. 2. Each cubby 300 can include an optional front rail 305 that can prevent the batteries from sliding out, for example from vibrations or an earthquake. The open ends 301 of the cubbies 300 are oriented such that the sidewalls 302 extend parallel to the first axis 101 and/or that a respective plane of each rear wall 303 is orthogonal to the first axis 101. The floor 304 of one cubby 300 can function as the ceiling 306 of a cubby 300 immediately below (e.g. in the same column). Similarly, the sidewalls 302 can be shared with neighboring cubbies 300 (e.g., in the same row).

The dimensions of each cubby 300 are larger than the respective dimensions of the battery to be inserted, for example to provide space for a robot (e.g., a robotic arm) to place a battery into the cubby 300 and to remove a battery from the cubby 300. Each cubby 300 includes an electrical terminal that is configured to be aligned with a corresponding electrical terminal on a battery such that an electrical connection is formed with the battery is placed in the cubby 300. The batteries can be charged and/or discharged via the electrical connection.

Each tray bay 310 (FIG. 2) is configured to releasably hold a respective battery tray 360. Each battery tray 360 holds one or more batteries 435. In an alternative embodiment, each tray bay 310 can releasably hold a respective battery 435. The cranes 320 are configured to transfer batteries 435 between the tray bays 310 and the cubbies 300. For example, the cranes 320 are configured to transfer discharged batteries 180 (FIG. 1) from the tray bays 310 to the cubbies 300 to be charged and to transfer charged batteries 190 (FIG. 1) from cubbies 300 to the tray bays 310 to be provided to an electric vehicle 150 (FIG. 1) using the battery-exchange robot 200.

The controller 230 (FIG. 1) can be in communication (e.g., wired or wireless communication) with the battery-storage apparatus 30 including the tray bays 310 and the cranes 320. Additionally or alternatively, the battery-storage apparatus 30 can include a controller 400 that is in communication (e.g., wired or wireless communication) with the tray bays 310 and the cranes 320. The controller 230, 400 can send control signals that can cause a tray bay 310 to hold or release a battery tray 360 (or battery) and to transfer a battery between the tray bay 310 and a cubby 300 (e.g., from the tray bay 310 to the cubby 300 or from the cubby 300 to the tray bay 310) using one or more cranes 320.

In some embodiments, the controller 400 can be in communication (e.g., wired or wireless communication) with the controller 230. For example, the controller 400 can receive control signals from the controller 230. The controller 230 can send control signals to the controller 400 that request a charged battery. In response, the controller 400 can send control signals to a crane 320 to retrieve a charged battery from a cubby 300. In some embodiments, the controller 400 can also send control signals to the battery-exchange robot 200 to bring the charged battery from the tray bay 310 to the electric vehicle 150. The controller 400 can send an acknowledgment to the controller 230 in response to the request for a charged battery. Additionally or alternatively, the controller 400 can notify the controller 230 that a charged battery is available on the tray bay 310, which can cause the controller 400 to send control signals to the battery-exchange robot 200 to bring the charged battery from the tray bay 310 to the electric vehicle 150.

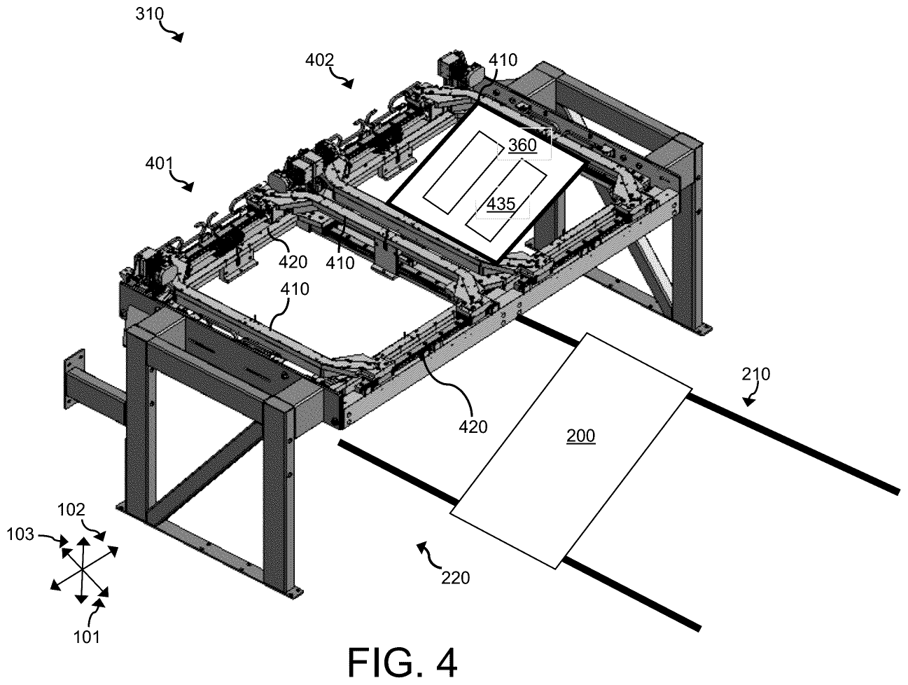

FIG. 4 is an isolated isometric view of the tray bays 310. The tray bays 310 include first and second frames 401, 402. In other embodiments, the tray bays 310 can include additional (e.g., 3 or more) or fewer (e.g., 1) frames.

Each frame 401, 402 is defined, at least in part, by a pair of robotic clamps (or robotic arms) 410 that extend parallel to the first axis 101. The robotic clamps 410 are configured to move or translate with respect to the second axis 102 to adjust the width of the respective frame 401, 402. For example, the robotic clamps 410 can be mounted on a pair of rails 420 that can further at least partially define each frame 401, 402. The rails 420 extend parallel to the second axis 102.

In operation, the robotic clamps 410 on each frame 401, 402 can move outwardly to increase the width of the frame 401, 402 to receive or release a battery tray 360 from the battery-exchange robot 200. After the battery-exchange robot 200 lifts the battery tray 360 into position (e.g., vertically with respect to the third axis 103 and horizontally with respect to the second axis 102), the robotic clamps 410 can move inwardly to decrease the width of the frame 401, 402 and hold the sides of the battery tray 360. The battery tray 360 is configured to hold at least one battery/battery module 435.

The battery-exchange robot 200 is located in the battery-exchange robot channel 220 below the tray bays 310 when placing or removing battery trays 360 into/from the tray bays 310.

Returning to FIG. 2, the cranes 320 are configured to move batteries 435 between the tray bays 360 and the cubbies 300. The cranes 320 can take charged (or partially charged) batteries 435 from the cubbies 300 and load the charged (or partially charged) batteries 435 onto the battery trays 360 secured in the tray bays 310. In addition, the cranes 320 can unload discharged (or partially discharged) batteries from the battery trays secured in the tray bays 310 and place the discharged (or partially discharged) batteries into the cubbies 300 to be charged or discharged.

The cranes 320 have multiple degrees of freedom of movement. For example, the cranes 320 can move slide along rails or tracks that extend parallel to the second axis 102. Belts, chains, and/or motors can be mechanically coupled to each crane 320 to move the crane 320 with respect to the rails/tracks. The cranes 320 can move along the same rails/tracks (e.g., common rails/tracks) or different rails/tracks.

Each crane 320 includes robotic grippers 350 that are configured to hold a battery 435. The robotic grippers 350 can move upward and downward (e.g., with respect to the third axis 103) and forward and backward (e.g., with respect to the first axis 101). In some embodiments, the robotic grippers 350 can pivot and/or rotate the battery 435. For example, the robotic grippers 350 can rotate the battery 435 within a plane, such as the plane defined by or parallel to the plane defined by the first and second axes 101, 102, the plane define by the first and third axes 101, 103, and/or the plane defined by the second and third axes 102, 103. In another example, the robotic grippers 350 can pivot the battery 435 with respect to an axis, such as with respect to or parallel to any of axes 101-103. Pivoting and/or rotating the battery 435 can be useful, for example when the orientation of the battery 435 needs to change between when the battery 435 is in the battery tray 360 (FIG. 4) and when the battery 435 is placed in a cubby (e.g., in the correct orientation to form an electrical connection to charge/discharge the battery).

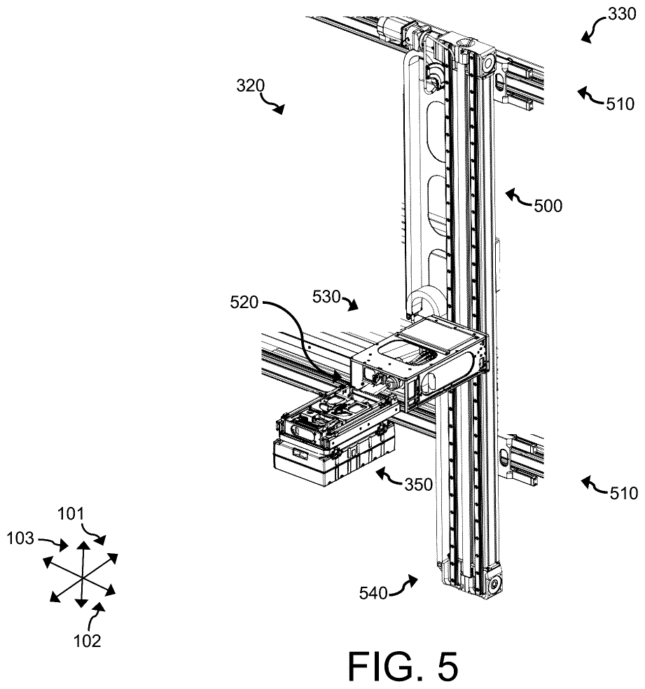

FIG. 5 is an isolated isometric view of one of the cranes 320. The crane 320 includes a shaft 500 that extends parallel to the third axis 103. The shaft 500 is mounted on rails 510 that extend parallel to the second axis 102. Due to the length of the shaft 500, the shaft 500 can be mounted or attached at two or more locations to a housing or frame. For example, the shaft 500 can be mounted on two or more sets of rails 510 to increase structural stability of the shaft 500. The rails 510 can form a portion of the housing 330.

FIG. 5 also illustrates the robotic grippers 350 in an extended state. The robotic grippers 350 can be extended using a telescoping arm 520. The telescoping arm 520 can extend and retract along or parallel to the first axis 101. In the contracted state, the robotic grippers 350 can fit within a base 530. The base 530 is attached to a vertical belt or track 540 on the shaft 500. The vertical belt/track 540 moves the base 530 including the robotic grippers 350 vertically upward and downward, with respect to the third axis 103, along the shaft 500.

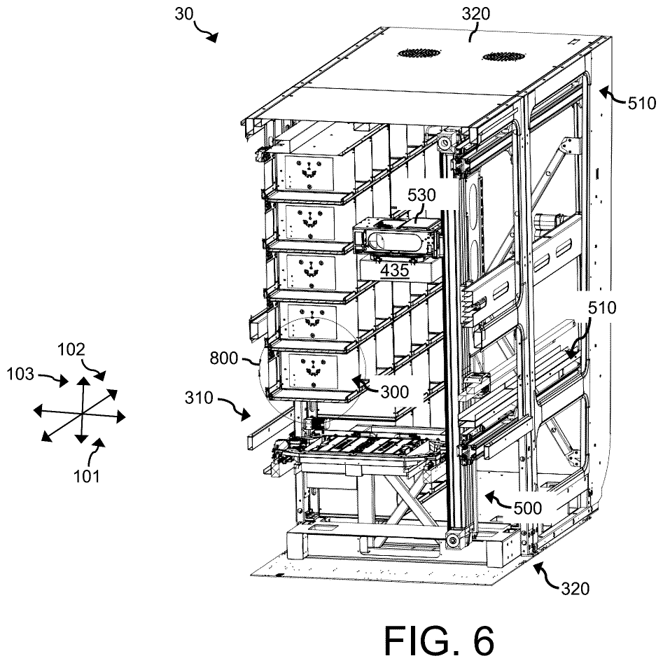

FIG. 6 is an isometric cross-sectional view of the battery-storage apparatus 30 taken through plane 600 to further illustrate one of the cranes 320 and one of the tray bays 310. The battery-exchange robot 200 is not illustrated in FIG. 6.

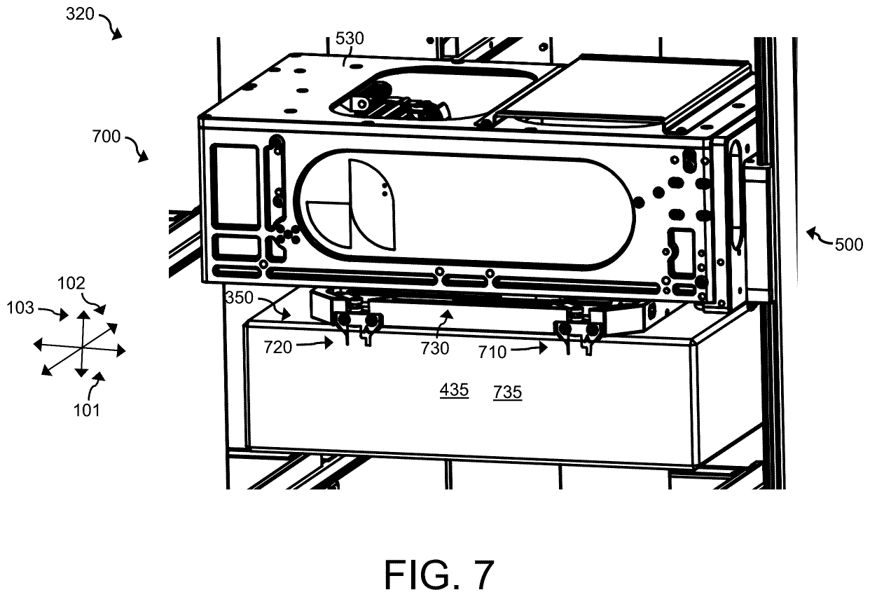

FIG. 7 is an enlarged view of the crane 320 illustrated in FIG. 6. The crane 320 includes a base 530 that includes a frame that has an open end 700 to allow the telescoping arm 520 to extend and contract with respect to the first axis 101.

The robotic grippers 350 include a plurality of fingers 710. Each finger 710 includes a planar surface that is configured to mechanically engage a planar side of the battery 435. The fingers 710 can be arranged in sets 720. In the illustrated embodiment, two sets 720 of fingers 710 mechanically engage a first side 735 of the battery 435. Two sets 720 of fingers 710 can mechanically engage a second side of the battery 435, where the first side 735 and the second side of the battery 435 are on opposing/opposite sides.

The fingers 710 (e.g., sets 720 of fingers 710) on a respective side of the battery 435 are mechanically attached to a respective robotic arm 730. Each robotic arm 730 is mechanically coupled to a respective motor that can move the respective arm 730 towards or away from the respective side of the battery 435 along or parallel to the second axis 102. A first robotic arm 730 can be mechanically coupled to the fingers 710 on the first side 735 of the battery 435. A second robotic arm can be mechanically coupled to the fingers 710 on the second side of the battery 435. When the robotic arms 730 are moved inwardly towards the battery 435 (and towards each other), the fingers 710 can apply a force against the sides of the battery 435 to hold the battery 435. When the robotic arms 730 are moved outwardly away the battery 435 (and from one another), the fingers 710 can release the force and release the battery 435.

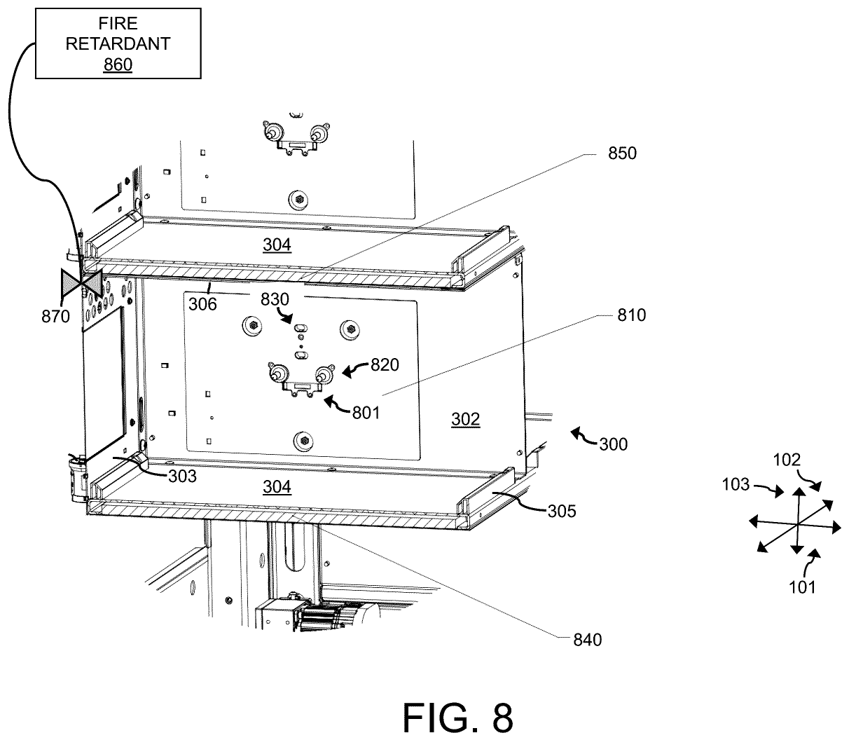

FIG. 8 is an enlarged view of the region 800 in FIG. 6 to further illustrate an example cubby 300. A high-voltage electrical port 801 is mounted on a surface or wall of the cubby 300 and is configured to mechanically and electrically mate with a corresponding electrical port in the battery 435. In the illustrated embodiment, the electrical port 801 is on the sidewall 302. In other embodiments, the electrical port 801 can be mounted on the floor 304 or rear wall 303. The electrical port 801 can be formed or mounted on a printed circuit board (PCB) 810 that is attached to the sidewall 302 (or alternatively to the floor 304 or rear wall 303).

The PCB 810 can include one or more alignment pins 820 or other alignment structures that can be configured to mechanically engage a complementary structure in the battery 435. The PCB 810 can also include laser holes 830 that are configured to reflect light from a laser mounted on the robotic grippers 350. The reflected light can be used to determine or confirm the distance between the laser and the PCB 810 when the robotic grippers 350 place or remove a battery into or from the cubby 300.

In some embodiments, the floor 304 can be temperature-controlled such as with a liquid or fluid that can circulate through a first set of coils or tubes 840 below the floor in a fluid loop. The liquid/fluid can cool the batteries such to prevent overheating. Additionally or alternatively, the liquid/fluid can warm the batteries, for example during cold weather, to improve charging.

In some embodiments, the ceiling 306 can include a second set of coils or tubes 850 that can be fluidly coupled to a reservoir of fire retardant 860. A valve 870 can be opened to cause the fire retardant 860 to flow through the coils/tubes 850 and through sprinklers on the ceiling 306 to spray the fire retardant 860 into the cubby 300 and onto the battery. The valve 870 can be temperature-activated or can be coupled to a temperature or fire sensor.

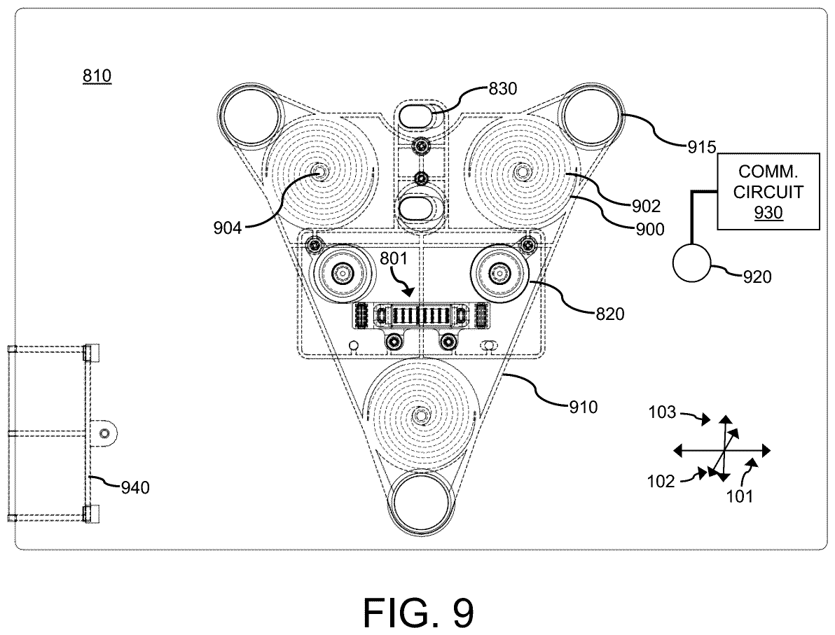

FIG. 9 is an isolated front view of the PCB 810 according to an embodiment. The isolated view reveals a plurality of flexible spirals or flexures 900 that are mounted on a support frame 910 for the PCB 810. The PCB 810 is rigidly mounted to the outside 902 of the spirals/flexures 900. The center 904 of each spiral/flexure 900 is rigidly mounted to the sidewall 302 of the cubby 300.

The flexible spirals 900 can allow the PCB 810 to float with respect to the first and third axes 101, 103. For example, when a battery is placed in a cubby, the battery may be slightly offset with respect to the alignment pins 820. In order to prevent a component from breaking, such as the sidewall, the PCB 810, and/or another component, the flexible spirals 900 allow the PCB 810 to be able to move a limited distance (e.g., within about 1-2 cm) parallel to the sidewall 302 (or other surface) such as with respect to the first axis 101 and/or with respect to the third axis 103 to reduce any force on the components.

The support frame 910 can be mounted on or attached to the sidewall 302 (or other surface) of the cubby 300. Alternatively, the support frame 910 can float and move with the PCB 810. The support frame 910 is generally triangular with mounting holes 915 in each corner. The flexible spirals 900 are located next to respective mounting holes 915. The mounting holes 915 are configured to receive a fastener such as a bolt to secure the support frame 910 to the sidewall 302 (or other surface) of the cubby 300.

An antenna 920 can be mounted on the PCB 810. The antenna 920 can be configured to receive electromagnetic signals that are produced by a corresponding circuit on the battery. The electromagnetic signals can represent the identity (e.g., serial number) of the battery and/or other information relating to the battery. The electromagnetic signals can be transmitted using inductive coupling such through near-field communication (NFC), through radio-frequency identification (RFID), or another technology. The antenna 920 can be electrically coupled to a communication circuit 930 that can drive the antenna 920 and/or that can analyze the received electromagnetic signals.

A plastic cover 940 for the high-voltage terminals can be provided to prevent high-voltage shorting to the sidewall 302 (or other surface) of the cubby 300.

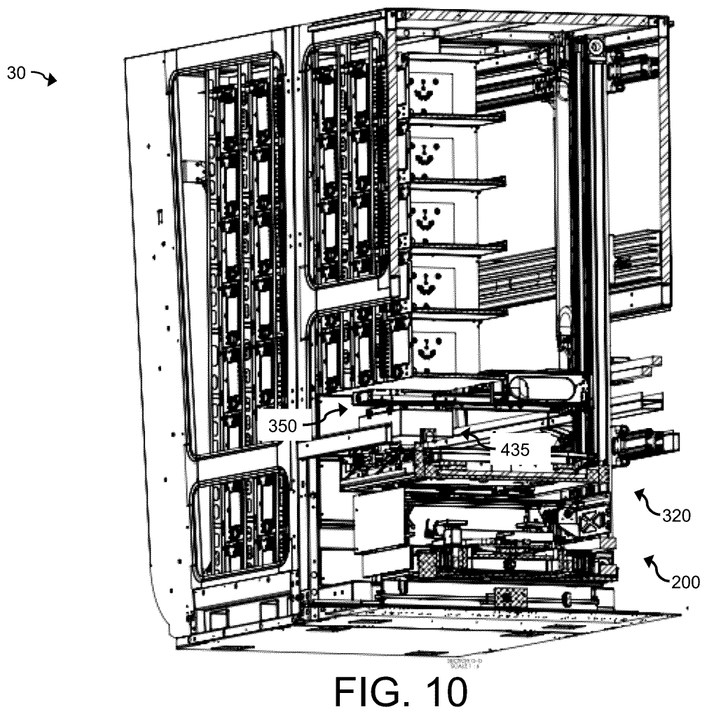

FIG. 10 is an isometric cross-sectional view of the battery-storage apparatus 30 taken through plane 600 is to further illustrate one of the cranes 320 when the robotic grippers 350 are extended.

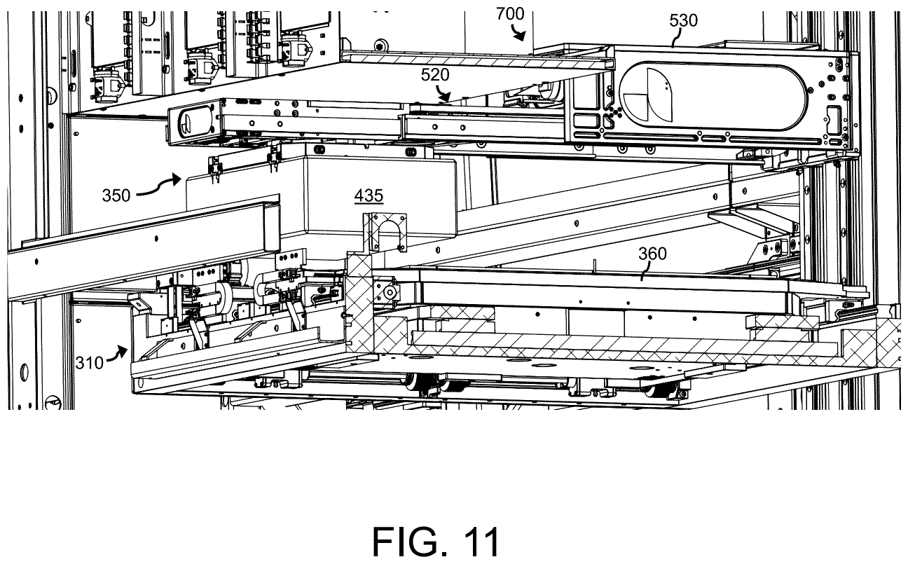

FIG. 11 is an enlarged view of the base 530 of the crane 320 illustrated in FIG. 10. The telescoping arm 520 is in an extended state to extend the robotic grippers 350 to the battery 435. The telescoping arm 520 passes through the open end 700 of the base 530. The battery 435 is lifted from a battery tray 360 in one of the tray bays 310.

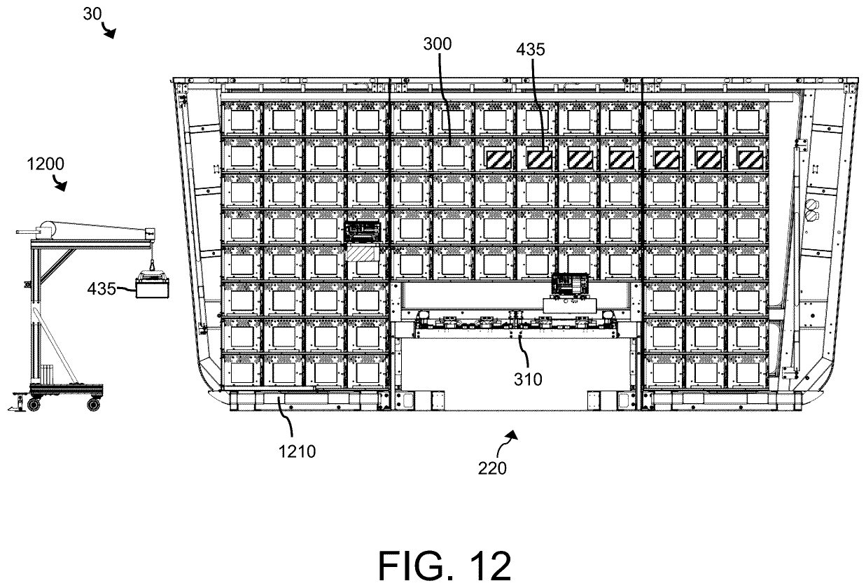

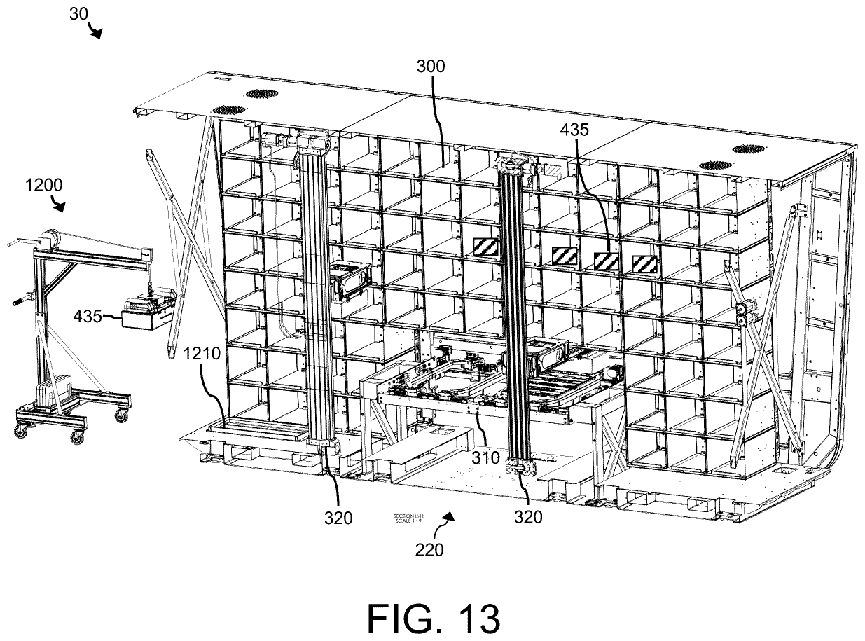

FIG. 12 is a front view of the battery-storage apparatus 30. A plurality of batteries 435 are in the cubbies 300 to be charged or discharged. This figure also illustrates a maintenance crane 1200 that can be used to add or remove batteries 435 to/from the battery-storage apparatus 30, such as for maintenance or when batteries fail. The maintenance crane 1200 can add or remove the batteries 435 into/from a battery loading port 1210, which is further illustrated in FIG. 13. The cranes 320 can transport batteries 435 between the battery loading port 1210, the cubbies 300, and the tray bays 310. The battery loading port 1210 can be located on either or both sides of the tray bays 310. It is noted that the shafts 500 (FIG. 5) of the cranes 320 are not illustrated in FIG. 12.

The battery-exchange robot 200 is not illustrated in FIGS. 12 and 13.

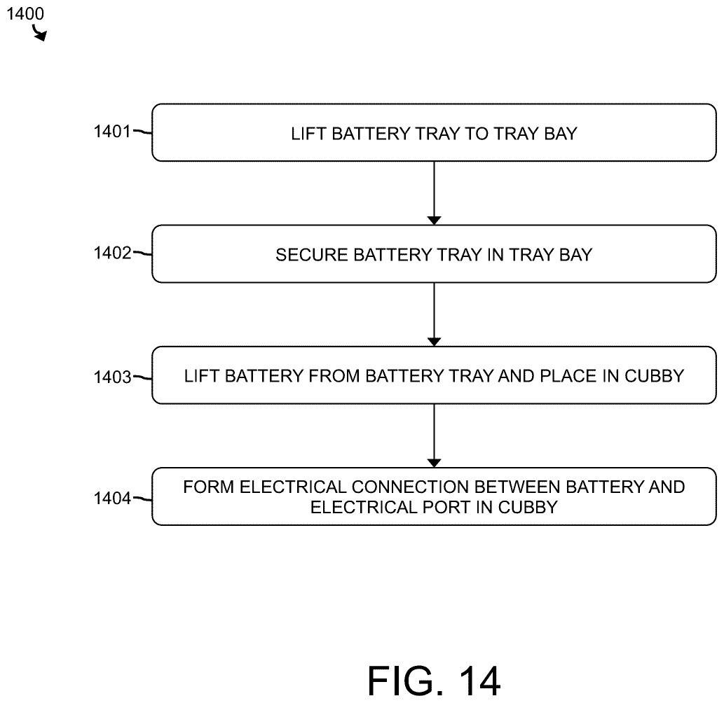

FIG. 14 is a flow chart of a method 1400 for adding batteries to the battery-storage apparatus 30.

In step 1401, the battery-exchange robot 200 is positioned in the battery-exchange robot channel 220 and lifts a battery tray 360 to one of the tray bays 310. The battery tray 360 includes one or more batteries 435.

In step 1402, the tray bay 310 secures the battery tray 360, for example by moving the robotic clamps 410 inwardly.

In step 1403, the robotic grippers 350 of one of the cranes 320 lift a battery 435 from the battery tray 360 in the tray bay 310 and places the battery 435 into a cubby 300. The crane 320 may move laterally with respect to the second axis 102 (e.g., along rails 510) to reach the tray bay 310 and/or to reach the cubby 300. In addition, the base 530 of the crane 320 may move vertically along the crane shaft 500 to adjust the vertical position of the robotic grippers 350 to reach the battery 435 in the battery tray 360 and/or to reach the cubby 300.

In step 1404, the battery 435 forms an electrical connection with the high-voltage electrical port 801 in the cubby 300. The high-voltage electrical port 801 can be used to charge and/or discharge the battery 435.

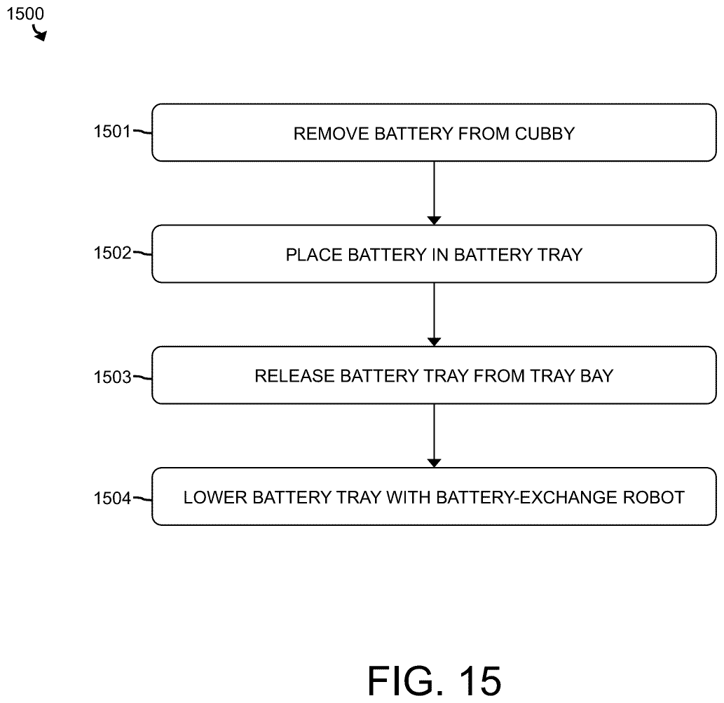

FIG. 15 is a flow chart of a method 1500 for removing batteries from the battery-storage apparatus 30.

In step 1501, the robotic grippers 350 of one of the cranes 320 remove a battery 435 from a cubby 300. The crane 320 may move laterally with respect to the second axis 102 (e.g., along rails 510) to reach the cubby 300. In addition, the base 530 of the crane 320 may move vertically along the crane shaft 500 to adjust the vertical position of the robotic grippers 350 to reach the battery 435 in the cubby 300.

In step 1502, the robotic grippers 350 of the crane 320 place the battery 435 into a battery tray 360 in one of the tray bays 310. The crane 320 may move laterally with respect to the second axis 102 (e.g., along rails 510) to reach the tray bay 310. In addition, the base 530 of the crane 320 may move vertically along the crane shaft 500 to adjust the vertical position of the robotic grippers 350 to reach the tray bay 310.

In step 1503, the tray bay 310 releases the battery tray 360, for example by moving the robotic clamps 410 outwardly.

In step 1504, the battery-exchange robot 200 lowers the battery tray 360. The battery tray 360 includes one or more charged batteries 435. The battery-exchange robot 200 can transport the battery tray 360 to a vehicle lift 100 to secure the battery tray 360 to an electric vehicle 150.

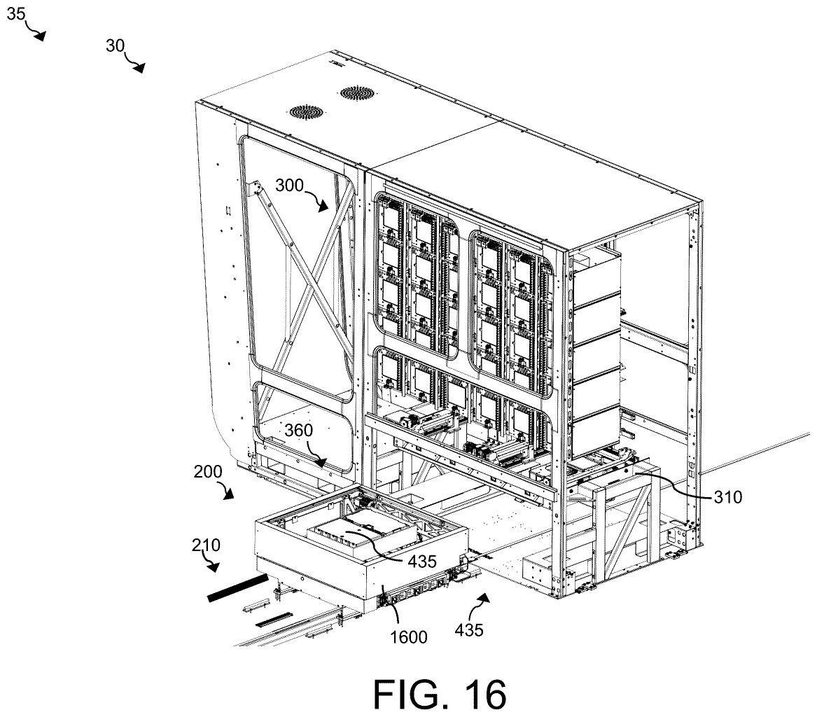

FIG. 16 is an isometric view of the battery-exchange system 35 where the battery-exchange robot 200 is disposed outside the battery-exchange robot channel 220. The battery-exchange robot 200 includes a battery receptacle 1600 that holds a battery tray 360 that includes batteries 435. The battery receptacle 1600 can include a cover for covering the battery tray 360 and any batteries 435 while the battery-exchange robot 200 is in motion, but the cover is not illustrated to not obscure the battery tray 360 and batteries 435. A motorized battery lift can be disposed in the battery receptacle 1600 to raise and lower the battery tray 360 including any batteries 435 in the battery tray 360. The motorized lift is in a lowered state. FIG. 16 can represent a first state of the battery-exchange system 35.

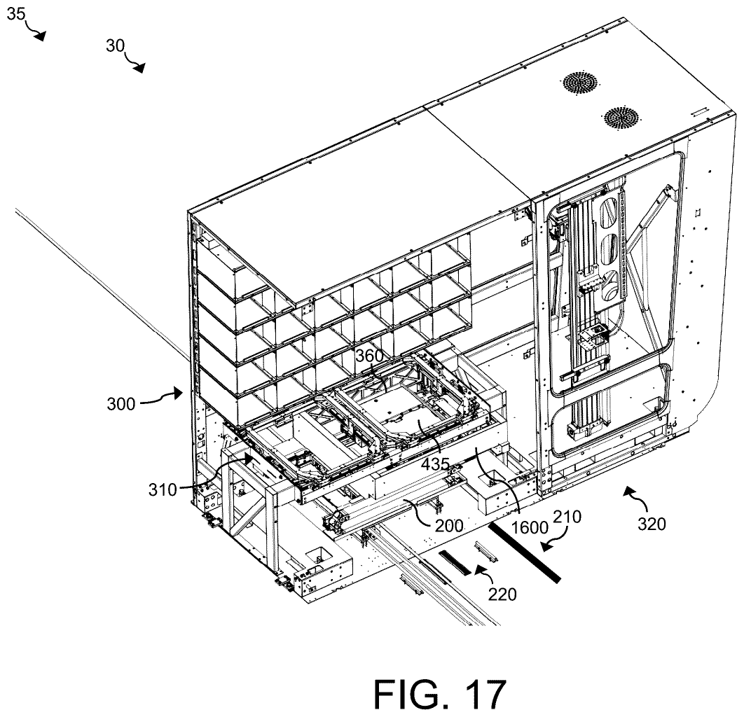

FIG. 17 is an isometric view of the battery-exchange system 35 where the battery-exchange robot 200 is disposed in the battery-exchange robot channel 220. The motorized battery lift in the battery receptacle 1600 is in a lowered state, as in FIG. 16. A crane 320 is shown positioned away from the tray bays 310. FIG. 17 can represent a second state of the battery-exchange system 35.

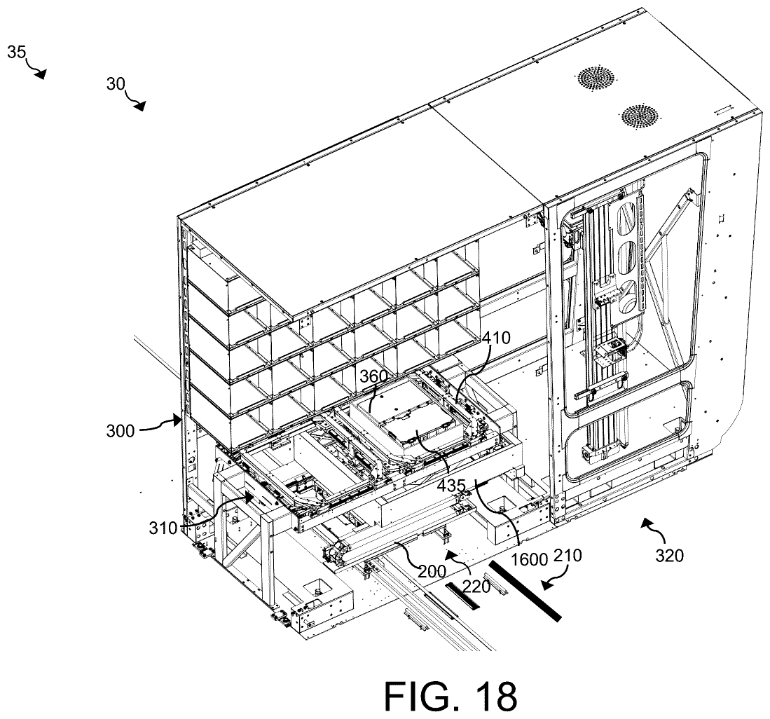

FIG. 18 is an isometric view of the battery-exchange system 35 where the battery-exchange robot 200 is disposed in the battery-exchange robot channel 220. The motorized battery lift in the battery receptacle 1600 is in a raised state to position the battery tray 360 level with the robotic clamps 410 of a tray bay 310. The crane 320 continues to be positioned away from the tray bays 310. FIG. 18 can represent a third state of the battery-exchange system 35.

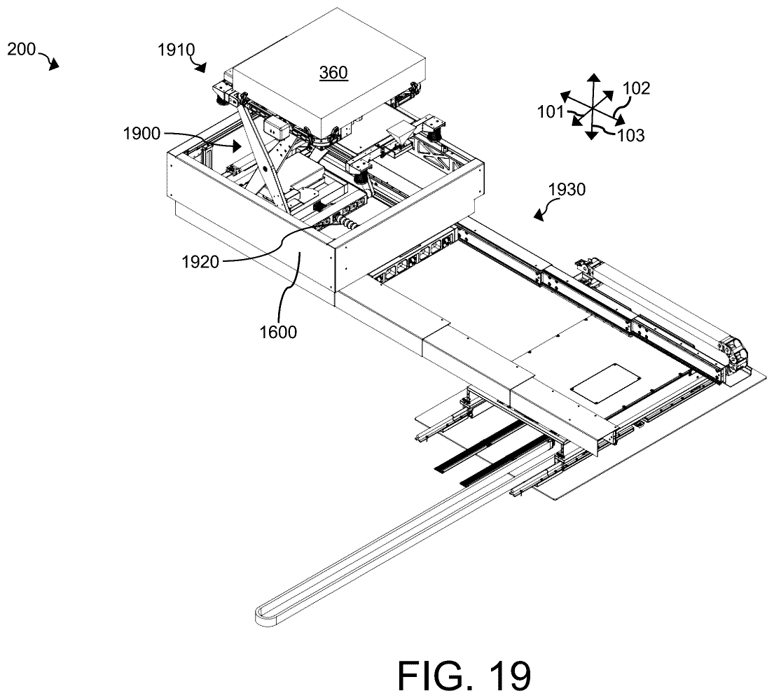

FIG. 19 is an isolated isometric view of the battery-exchange robot 200 when a motorized battery lift 1900 is in a raised position. The motorized battery lift 1900 in the battery receptacle 1600 is mechanically coupled to a battery holding device 1910 that is configured to releasably hold a battery tray 360. When the battery holding device 1910 is holding a battery tray 360, the battery tray 360 is raised and lowered with the battery holding device 1910. The motorized battery lift 1900 can be driven by a lead screw 1920 that can be coupled to a motor. The motorized battery lift 1900 can be a scissor lift or another lift.

The battery-exchange robot can include telescoping arms 1930 can extend or contract with respect to the second axis 102 to position the battery receptacle 1600 with respect to an appropriate battery tray bay 310 and with respect to the underside of a vehicle 150 (FIG. 1).

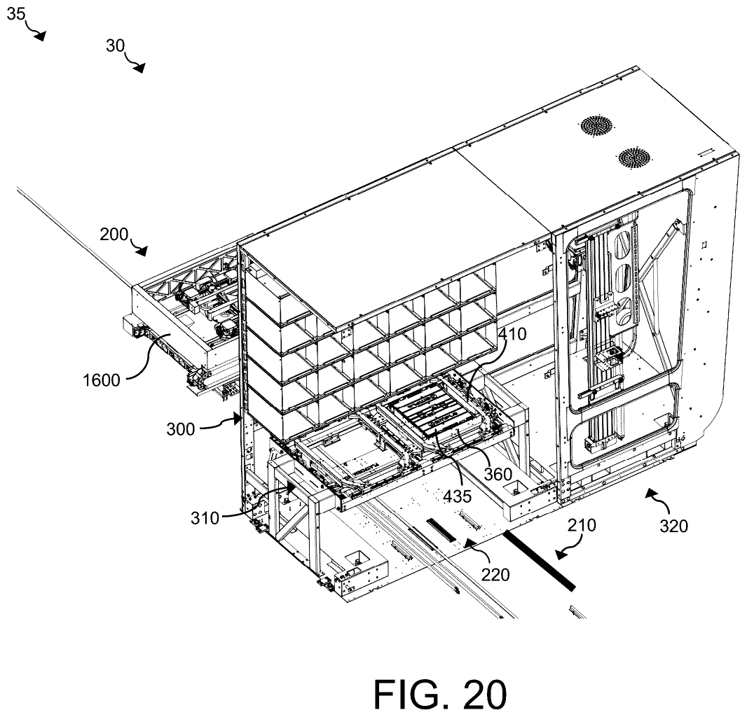

FIG. 20 is an isometric view of the battery-exchange system 35 where the robotic clamps 410 are holding the battery tray 360 in the tray bay 310. The battery-exchange robot 200 has moved away from the battery-exchange robot channel 220, for example towards a vehicle 150. The crane 320 continues to be positioned away from the tray bays 310. FIG. 20 can represent a fourth state of the battery-exchange system 35.

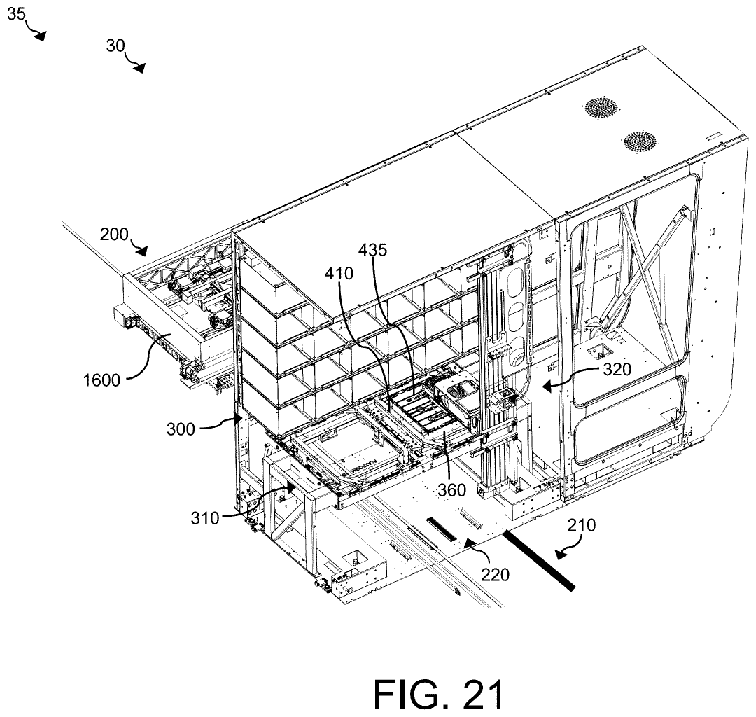

FIG. 21 is an isometric view of the battery-exchange system 35 where the crane 320 is positioned to pick up a battery 435 from the battery tray 360 in the tray bay 310. FIG. 21 can represent a fifth state of the battery-exchange system 35.

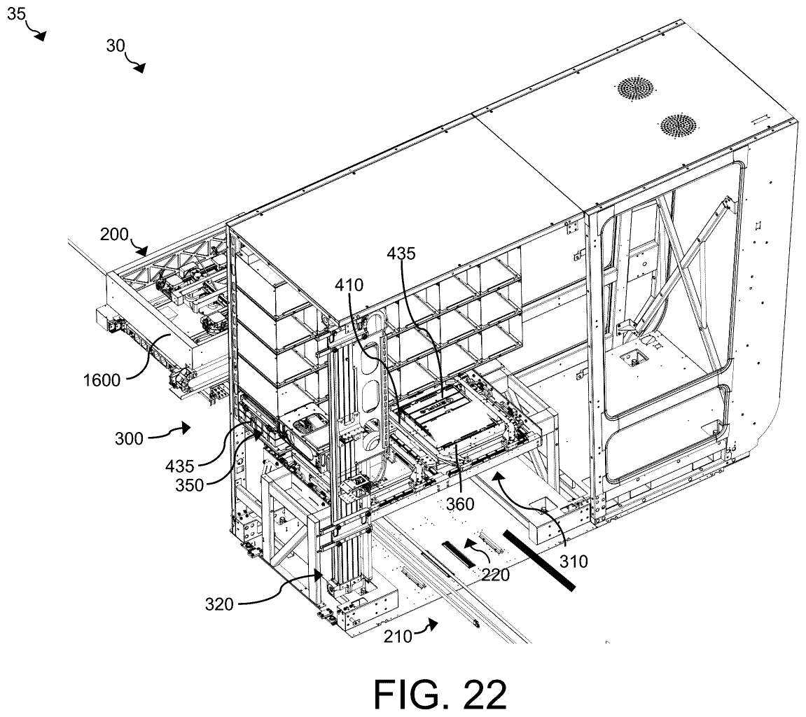

FIG. 22 is an isometric view of the battery-exchange system 35 where the crane 320 has picked up a battery 435 from the battery tray 360 in the tray bay 310 and is placing the battery 435 in a cubby 300 for charging. The crane 32 holds the battery 435 using robotic grippers 350. FIG. 22 can represent a sixth state of the battery-exchange system 35.

Referring to method 1400, step 1401 can be illustrated in FIG. 18. FIGS. 16 and 17 can represent respective times before step 1401 when the battery-exchange robot 200 is moving towards and into the battery-exchange robot channel 220. Step 1402 can be illustrated in FIG. 20. Step 1403 and 1404 can be illustrated in FIGS. 21 and 22.

FIGS. 16-18 and 20-22 can also be viewed as a reverse time series to illustrate the unloading of a battery 435 from a cubby 300. For example, FIG. 22 can illustrate an isometric view of the battery-exchange system 35 where the crane 320 has picked up a battery 435 from a cubby 300 after charging is complete. FIG. 21 can illustrate an isometric view of the battery-exchange system 35 where the crane 320 has placed the battery 435 into the battery tray 360 in the tray bay 310. FIG. 20 can illustrate an isometric view of the battery-exchange system 35 where the crane 320 has moved away from the tray bays 310 (after placing the battery into the battery tray 360 in FIG. 21). FIG. 18 can illustrate an isometric view of the battery-exchange system 35 where the robotic clamps 410 have moved outwardly to release the battery tray 360 from the tray bay 310 while the motorized battery lift (e.g., into the battery holding device 1910 on motorized lift 1900 (FIG. 19)) is in a raised position. FIG. 17 can illustrate an isometric view of the battery-exchange system 35 where the motorized battery lift has lowered the battery tray 360 from the tray bay 310 to the battery receptacle 1600. FIG. 17 can illustrate an isometric view of the battery-exchange system 35 where battery-exchange robot 200 is moving away from the battery-exchange robot channel 220 such as to transport the charged battery 435 to a vehicle 150 (FIG. 1)

Referring to method 1500, step 1501 can be illustrated in FIG. 22. Step 1502 can be illustrated in FIGS. 20 and 21. Step 1503 can be illustrated in FIG. 18. Step 1504 can be represented in FIG. 17. FIG. 16 can represent a time occurring after step 1504.

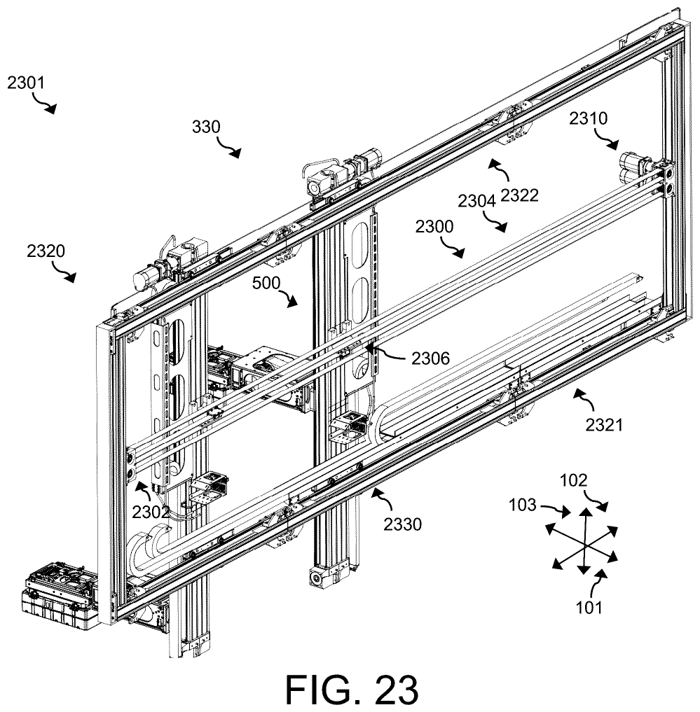

FIG. 23 is an isolated isometric rear view of crane assembly 2301 to illustrate the drive assemblies for the cranes 320 according to an embodiment. The shaft 500 of each crane 320 is mechanically coupled to a respective belt 2300 that extends parallel to the second axis 102. The belts 2300 can be connected to pulleys 2302 such that each belt 2300 forms a respective belt loop 2304. Each belt 2300 is driven by a separate motor 2310. For example, a respective motor 2310 can drive a pulley 2302 which can be referred to as a drive pulley. Each shaft 500 can be mechanically coupled to and/or mechanically attached to a respective belt 2300 by a respective clamp 2306. The drive assemblies for the cranes 320 can be controlled by a controller such as controller 230.

The shafts 500 are mounted on a frame 2320 that includes a lower track 2321 and an upper track 2322. The lower and upper tracks 2321, 2322 extend parallel to each other and to the second axis 102. Each shaft 500 includes wheels 2330 that mechanically engage the lower and upper tracks 2321, 2322.

Each motor 2310 can drive a respective belt 2300 (or respective belt loop 2304) in a first direction (e.g., clockwise) or in a second direction (e.g., counterclockwise). Driving a belt 2300 (or belt loop 2304) in the first direction causes the attached shaft 500 to move or translate laterally and parallel to the second axis 102, using the respective wheels 2330 of the shaft 500, in a first direction (e.g., towards the left in FIG. 23). Driving a belt 2300 (or belt loop 2304) in the second direction causes the attached shaft 500 to move or translate laterally and parallel to the second axis 102, using the respective wheels 2330 of the shaft 500, in a second direction (e.g., towards the right in FIG. 23).

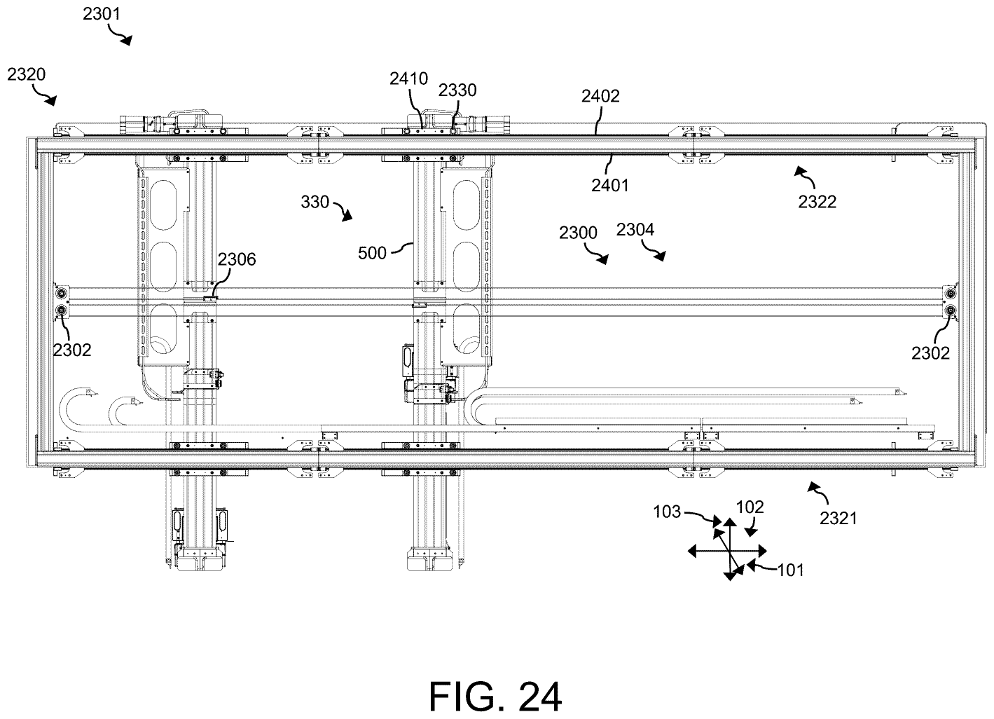

FIG. 24 is an isolated rear view of the crane assembly 2301 according to an embodiment. The rear view further illustrates that the lower and upper tracks 2321, 2322 each include first and second rails 2401, 2402. One or more wheels 2330 is/are configured to mechanically engage each of the first and second rails 2401, 2402 of the lower tracks 2321 and each of the first and second rails 2401, 2402 of the upper tracks 2322. The wheel(s) 2330 can be attached to sleds 2410. For example, the wheel(s) 2330 that mechanically engage the first rail 2401 of the lower tracks 2321 can be attached to a first sled 2410, the wheel(s) 2330 that mechanically engage the second rail 2402 of the lower tracks 2321 can be attached to a second sled 2410, the wheel(s) 2330 that mechanically engage the first rail 2401 of the upper tracks 2322 can be attached to a third sled 2410, and/or the wheel(s) 2330 that mechanically engage the second rail 2402 of the upper tracks 2322 can be attached to a fourth sled 2410.

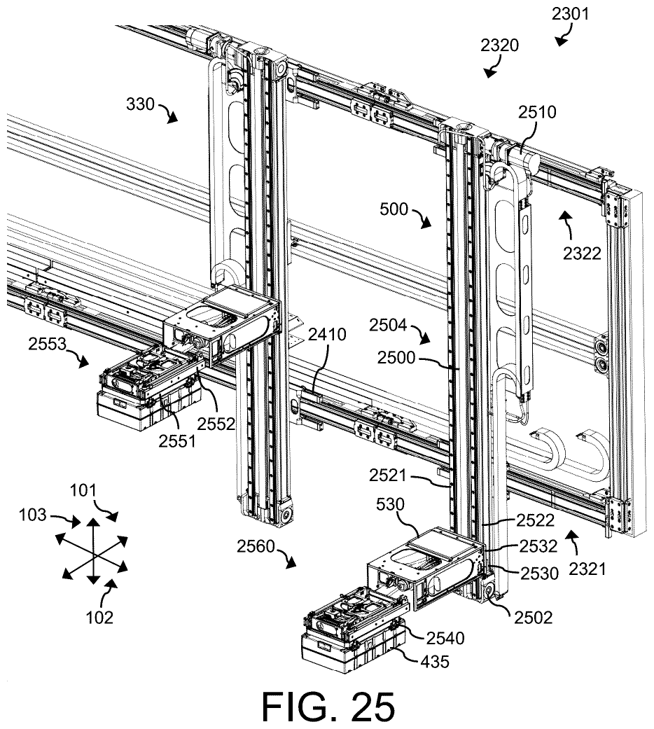

FIG. 25 is an isolated isometric front view of the crane assembly 2301 according to an embodiment. The base 530 of each crane 350 is mechanically coupled (e.g., using a clamp that can be the same as clamp 2306) to a belt 2500 disposed on or in the shaft 500. The belt 2500 extends parallel to the third axis 103. The belt 2500 can pass over pulleys 2502 at opposing ends of the belt 2500 such that the belt 2500 forms a belt loop 2504. The belt 2500 is driven by a motor 2510 that can be disposed at one end of the belt 2500. For example, the motor 2510 can drive a pulley 2502 which can be referred to as a drive pulley.

Each motor 2510 can drive a respective belt 2500 (or respective belt loop 2504) in a first direction (e.g., clockwise) or in a second direction (e.g., counterclockwise). Driving a belt 2500 (or belt loop 2504) in the first direction causes the attached base 530 to move or translate vertically and parallel to the third axis 103 in a first direction (e.g., upwards in FIG. 25). Driving a belt 2500 (or belt loop 2504) in the second direction causes the attached base 530 to move or translate vertically and parallel to the third axis 103 in a second direction (e.g., downwards in FIG. 25).

Each shaft 500 include a first track 2521 and a second track 2522. The belt 2500 is disposed between the first and track tracks 2521, 2522. The first and second tracks 2521, 2522 extend parallel to each other and to the third axis 103. The base 530 includes wheels 2530 that mechanically engage the first and track tracks 2521, 2522. The wheels 2530 can be the same as the wheel(s) 2330. The wheels 2330 can be attached to a sled 2532 that is attached to a distal end of the base 530 and disposed between the distal end of the base 530 and the shaft 500.

Each crane 350 is shown holding a respective battery 435. Each battery 435 is reliably held by a plurality of latches or fingers (in general, latches) 2540 mechanically coupled to a lower assembly 2551. The lower assembly 2551 is mechanically coupled to an upper assembly 2552 that is disposed on and/or in direct physical contact with the lower assembly 2551. The upper and lower assemblies 2551, 2552 comprise a moveable assembly 2553 that can be moved parallel to the first axis 101 towards or away from the base 530.

The base 530 and the moveable assembly 2553 can comprise an end effector assembly 2560.

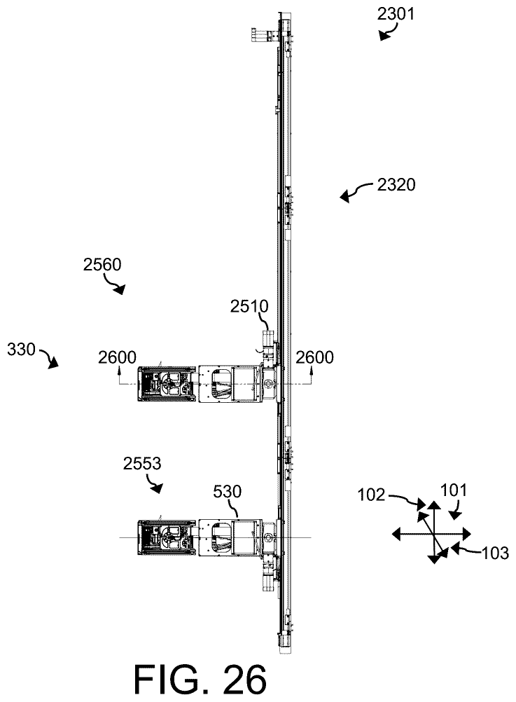

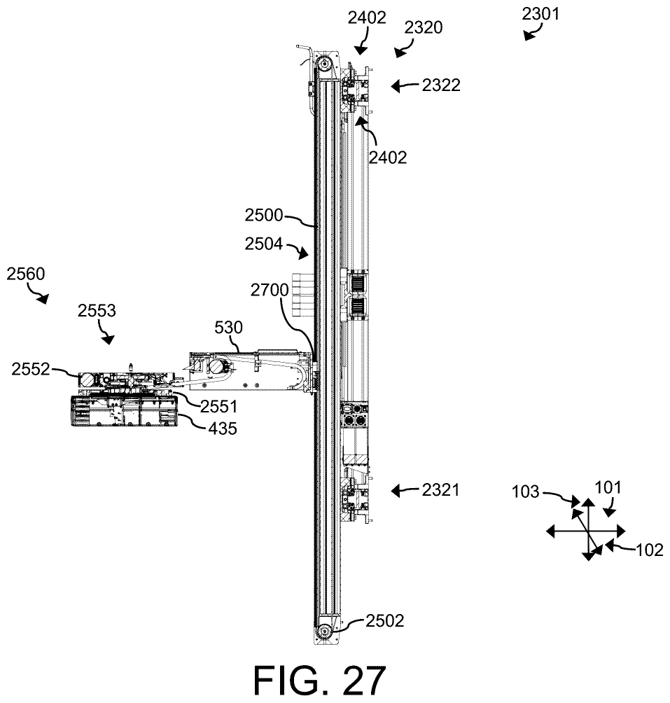

FIG. 26 is an isolated top view of the crane assembly 2301 according to an embodiment. FIG. 27 is a cross section through plane 2600 in FIG. 26 according to an embodiment. The cross section shown in FIG. 27 provides additional details of the belt 2500, belt loop 2504, pulleys 2502, and the frame 2320 including the lower track 2321 and the upper track 2322. The cross section also illustrates a clamp 2700 that mechanically couples the distal end of the base 530 to the belt 2500 (or belt loop 2504).

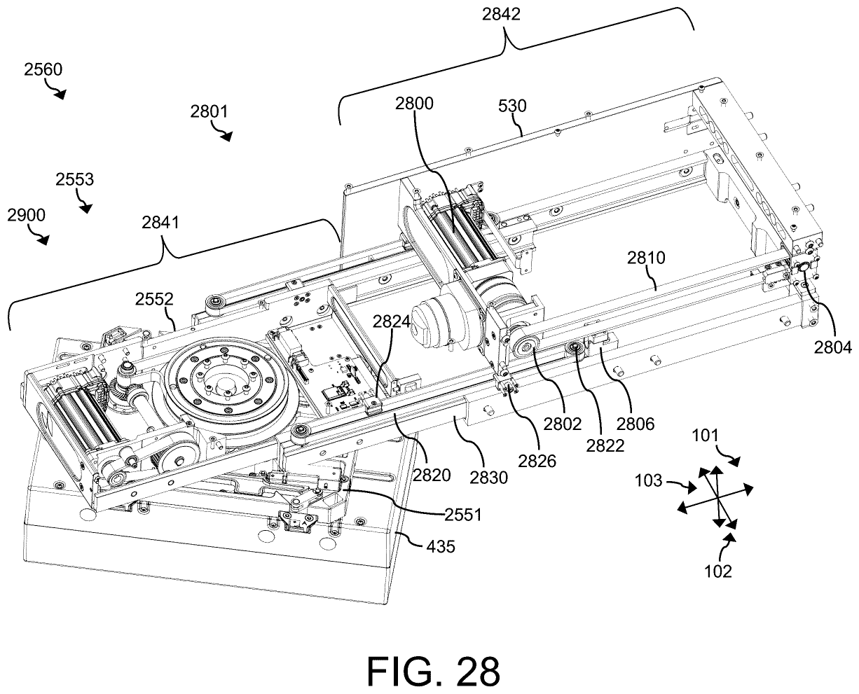

FIG. 28 is an isometric view of the end effector assembly 2560 according to an embodiment. One or more housings is/are removed to illustrate some of the drive assemblies for the end effector assembly 2560. The drive assemblies for the end effector assembly 2560 can be controlled by a controller such as controller 230.

The end effector assembly 2560 includes an extension drive assembly 2801 that is configured to extend and retract the moveable assembly 2553 parallel to the first axis 101. In addition, the moveable assembly 2553 includes a rotational drive assembly 2900 that causes the lower assembly 2551 to rotate relative to the upper assembly 2552. The rotational drive assembly 2900 can be optional in some embodiments.

The moveable assembly 2553 is configured to move parallel to the first axis 101 towards or away from the base 530. The drive mechanism for moving the moveable assembly 2553 with respect to the first axis 101 includes a first motor 2800, a drive belt 2810, and one or more synch belts 2820. The first motor 2800 drives a drive pulley 2802 that is mechanically coupled to the drive belt 2810 which passes over a second pulley 2804.

A clamp 2806 attached to an intermediate stage 2830 mechanically couples the drive belt 2810 to the intermediate stage 2830 such that the intermediate stage 2830 moves parallel to the first axis 101 according to a position and/or a direction of movement of the drive belt 2810. The synch belt(s) 2820 is/are disposed on the intermediate stage 2830. Each synch belt 2820 passes over pulleys 2822 which can be passive pulleys. A first clamp 2824 mechanically couples a respective synch belt 2820 to the upper assembly 2552. A second clamp 2826 mechanically couples the respective synch belt 2820 to the base 530. Two synch belts 2830 are shown, but there can be additional or fewer synch belts 2830 in other embodiments. The synch belts 2830 are spaced apart from each other with respect to the secondo axis 102. The synch belts 2830 can be disposed on opposing sides of the intermediate stage 2830.

Moving the intermediate stage 2830 parallel to the first axis 101 drives the synch belt(s) 2820 which cause the upper assembly 2552 to move parallel to the first axis 101. For example, moving the intermediate stage 2830 away from the base 530 causes the synch belt(s) 2820 to move in a first direction (e.g., clockwise) which causes the upper assembly 2552 to move away from the base 530 and away from the intermediate stage 2830. Moving the intermediate stage 2830 towards from the base 530 causes the synch belt(s) 2820 to move in a second direction (e.g., counterclockwise) which causes the upper assembly 2552 to move toward the base 530 and toward the intermediate stage 2830. The upper assembly 2552 is mechanically coupled to the lower assembly 2551 such that the lower assembly 2551 moves towards or away from the base 530 with the upper assembly 2552 (e.g., together as the moveable assembly 2553).

The moveable assembly 2553 is illustrated in a fully-opened state in which the intermediate stage 2830 has been moved a maximum distance away from the base 530 and the upper assembly 2552 has been moved a maximum distance away from the intermediate stage 2830. In the fully opened state, the extension length 2841 (measured parallel to the first axis 101) of the intermediate stage 2830 and the upper assembly 2552 can be equal to or about equal to the length 2842 of the base 530 (measured parallel to the first axis 101), which can be referred to as a 100% extension. In a fully retracted state, the intermediate stage 2830 and the upper assembly 2552 are disposed in the base 530, for example as illustrated in FIGS. 2 and 6.

A different extension percentage can be provided in other embodiments. For example, the intermediate stage 2830 (including the synch belt(s) 2820, pulleys 2822, and clamps 2824, 2826) can be removed in some embodiments such that the drive pulley is mechanically coupled directly to the upper assembly 2552, which would provide a smaller percentage extension (e.g., about 50% extension). In other embodiments, the moveably assembly 2553 can include multiple intermediate stages that can be connected to one another using respective synch belts, pulleys, and clamps to provide a larger percentage extension (e.g., about 150% or a higher percentage extension).

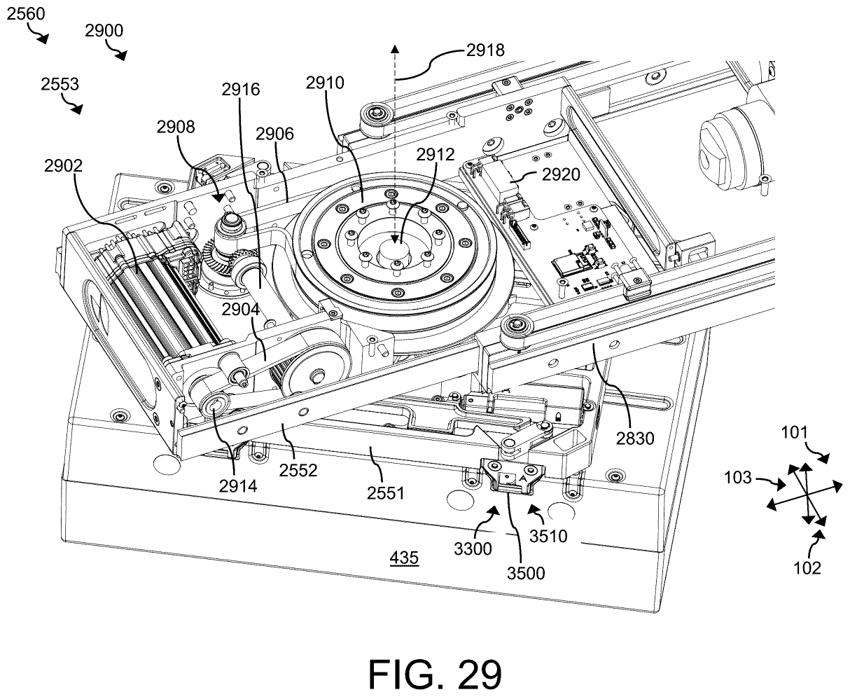

FIG. 29 is a detailed view of the moveable assembly 2553 shown in FIG. 28 to further illustrate the rotational drive assembly 2900 according to an embodiment. The rotational drive assembly 2900 can be controlled by a controller such as controller 230.

The rotational drive assembly 2900 includes a motor 2902, a drive belt 2904, a right-angle gear set 2906, a rotational drive belt 2908, a rotational pulley 2910, and a shaft 2912. The motor 2902 is configured to drive the drive belt 2904 which passes over a pulley 2914 and a gear at the end of a shaft 2916. Movement of the drive belt 2904 causes the shaft 2916 to rotate, which causes the right-angle gear set 2906 to engage. The right-angle gear set 2906 is mechanically coupled to the shaft 2916. The right-angle gear set 2906 is configured to drive the rotational drive belt 2908 which extends around at least a portion of the rotational pulley 2910. Movement of the rotational drive belt 2908 causes the rotational pulley 2910 to rotate which rotates the shaft 2912. The shaft 2912 extends to and is mechanically coupled to the lower assembly 2551. Rotation of the shaft 2912 causes the lower assembly 2551 to rotate about a shaft axis 2918 that passes through the shaft 2912. The shaft axis 1918 is parallel to the third axis 103.

When the motor 2902 rotates in a first direction (e.g., clockwise), the drive belt 2904, the right-angle gear set 2906, the rotational drive belt 2908, the rotational pulley 2910, and the shaft 2912 are moved in respective first directions such that the lower assembly 2551 rotates in a first direction (e.g., clockwise) relative to the upper assembly 2552. When the motor 2902 rotates in a second direction (e.g., counterclockwise), the drive belt 2904, the right-angle gear set 2906, the rotational drive belt 2908, the rotational pulley 2910, and the shaft 2912 are moved in respective second directions such that the lower assembly 2551 rotates in a second direction (e.g., counterclockwise) relative to the upper assembly 2552. A limit switch 2920 can be coupled to the rotational pulley 2910 to indicate when the lower assembly 2551 is aligned (e.g., at 0°) with the upper assembly 2552. The number of rotations for the motor 2902 to place the lower assembly 2551 at different rotational angles relative to the upper assembly 2552 can be calibrated and stored in the memory of the controller, for example as a look-up table and/or as a model.

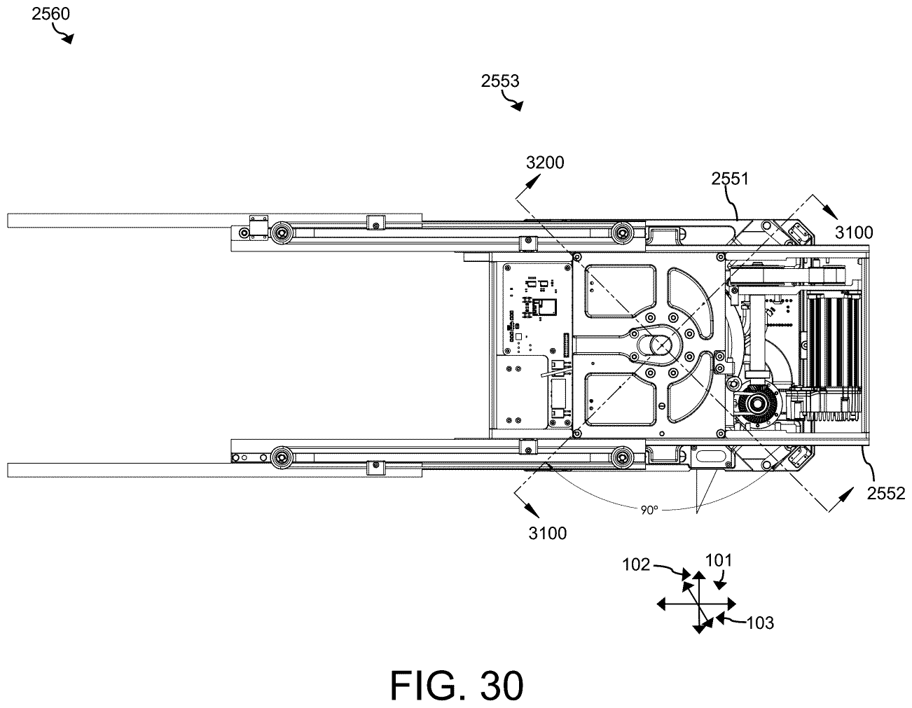

FIG. 30 is a top view of the end effector assembly 2560 according to an embodiment. The portion of the extension drive assembly 2801 in the base 530 (e.g., motor 2800) is not illustrated in this figure.

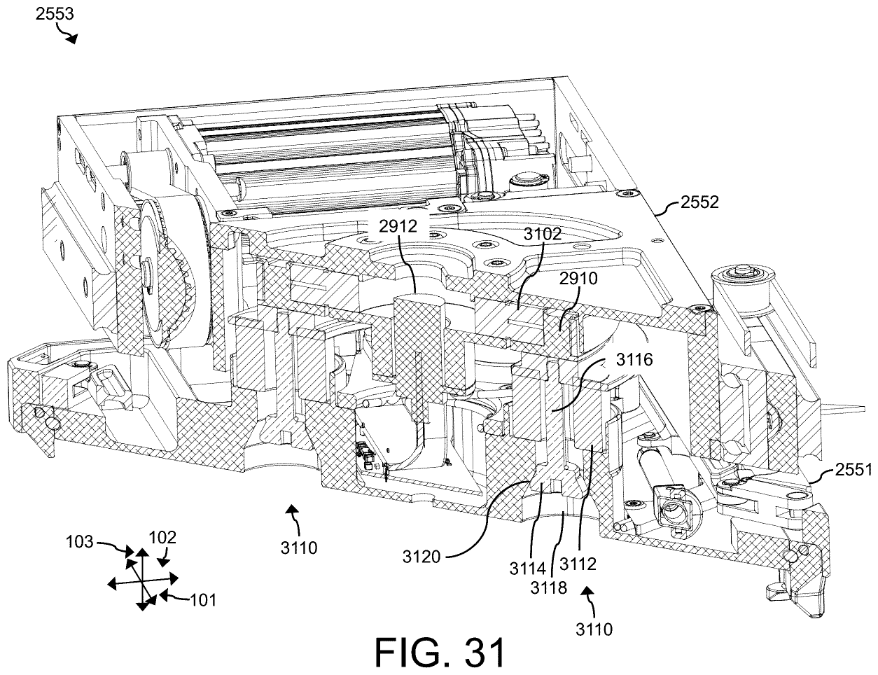

FIG. 31 is a cross section of the end effector assembly 2560 through plane 3100 in FIG. 30 according to an embodiment. The cross section further illustrates how the shaft 1912 mechanically engages and rotates the lower assembly 2551 relative to the upper assembly 2552. The shaft 1912 can alternately be referred to as a slip ring. A rotational bearing 3102 is mechanically engaged by the rotational pulley 2910 as the rotational pulley 2910 is rotated.

The cross section also shows a compliant connections 3110 between the lower and upper assemblies 2551, 2552. The compliant connections 3110 allow the lower assembly 2551 to move vertically (e.g., parallel to the third axis 103) and/or laterally (e.g., relative to the first and/or second axes 101, 102). Each compliant connection 3110 includes a respective spring 3112 and a respective cone 3114. The cone 3114 is disposed at the end of a shaft 3116 that is mechanically coupled to the upper assembly 2552. The cone 3114 is disposed in a tapered, conical, and/or chamfered cylinder 3118 in the lower assembly 2551. The cone 3114 mechanically engages a narrowed/tapered end 3120 of the cylinder 3118, which has a smaller dimension (e.g., diameter) than that of the cone 3114, to mechanically coupled the lower and upper assemblies 2551, 2552.

When an upward force is applied to the lower assembly 2551, for example when picking up a battery, the spring 3112 is compressed and the cone 3114 moves away from the narrowed/tapered end 3120 of the cylinder 3118 to provide compliance in the vertical direction (e.g., parallel to the third axis 103). In addition, when the spring 3112 is compressed and the cone 3114 moves away from the narrowed/tapered end 3120 of the cylinder 3118, the inner diameter of the cylinder 3118 is larger than the outer diameter of the cone 3114 to provide compliance in the lateral directions (e.g., with respect to the first and/or second axes 101, 102). The spring 3116 can be partially compressed in some embodiments.

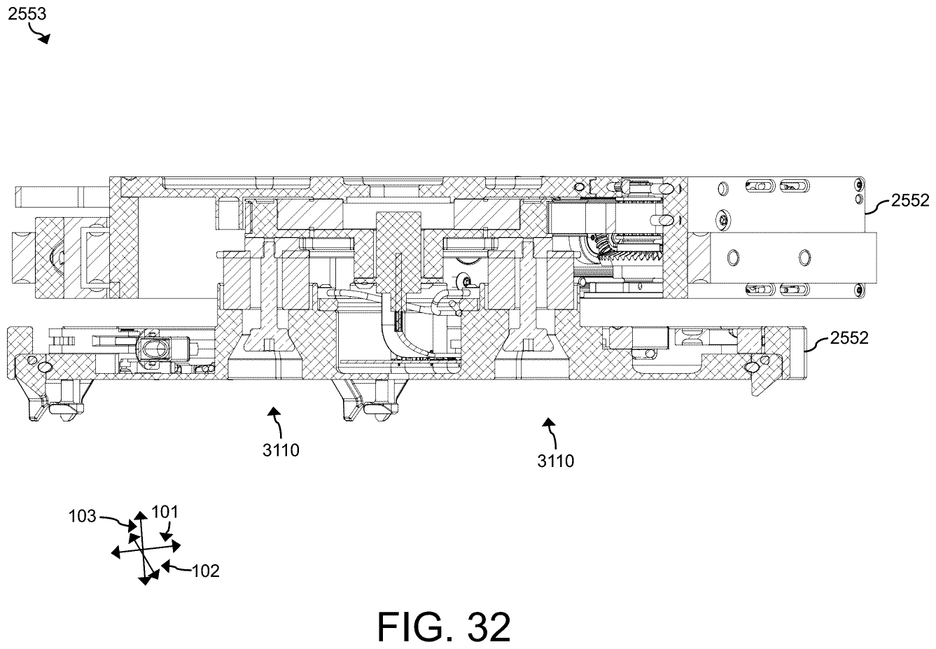

FIG. 32 is a cross section of the end effector assembly 2560 through plane 3100 in FIG. 30 according to an embodiment. The cross section in FIG. 32 shows two additional compliant connections 3110. Thus, the end effector assembly 2560 includes four compliant connections 3110. In general, there can be a plurality of compliant connections 3110 such as 2-6 compliant connections 3110 or any number therebetween such as 3, 4, or 5 compliant connections 3110.

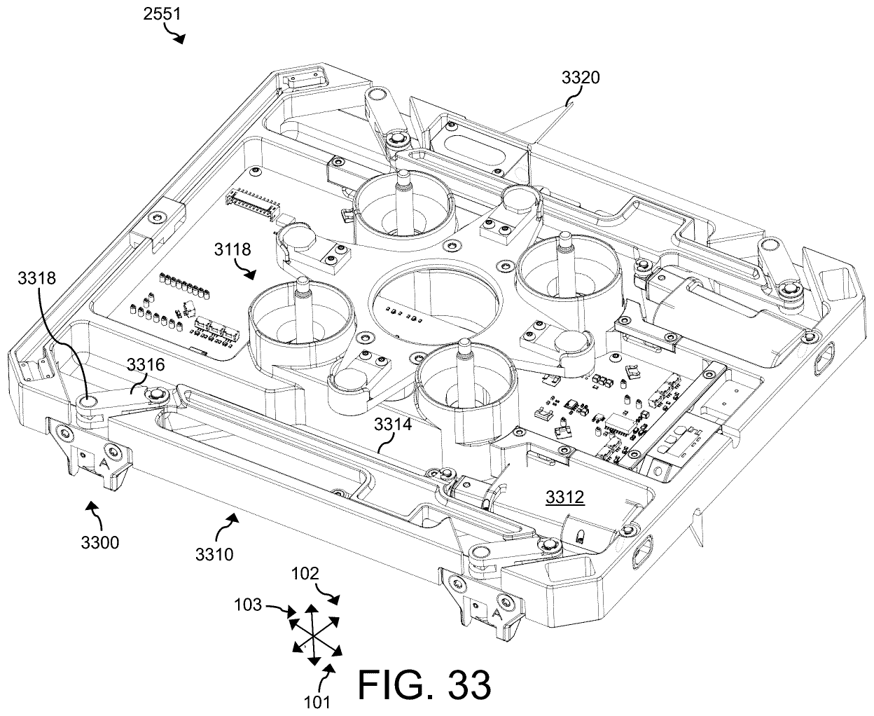

FIG. 33 is an isometric view of the lower assembly 2551 according to an embodiment. The lower assembly 2551 includes four latches 3300. The latches 3300 are configured to transition between a locked state and an unlocked state. The latches 3300 are shown in the unlocked state in FIG. 33.

Latch drive assemblies 3310 are mounted on the lower assembly 2551. The drive assemblies 3310 can be controlled by a controller such as controller 230.

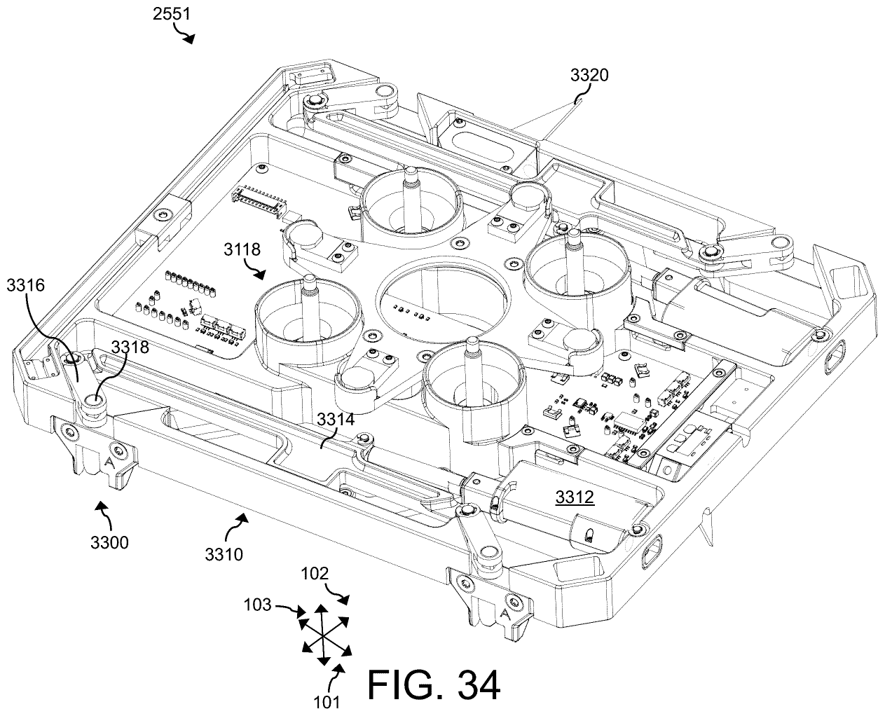

A first latch drive assembly 3310 drives a first pair of latches 3300. A second latch drive assembly 3310 drives a second pair of latches 3300. Each latch drive assembly 3310 includes a respective linear actuator 3312, a respective drive link bar 3314 and a pair of latch link bars 3316. The linear actuator 3312 is mechanically coupled to the drive bar 3314 to position the drive bar 3314 towards or away from the linear actuator 3312 (e.g., relative to the first axis 101). The latch link bars 3316 are mechanically coupled to the drive link bar 3314. Each latch link bar 3316 is configured to mechanically engage a respective shaft 3318 that is mechanically coupled and/or mechanically attached to a respective latch 3300. When the linear actuator 3312 is in a first state (e.g., a contracted state), the drive link bar 3314 is in a first position that causes the latch link bars 3316 to be in respective first positions such that the respective latches 3300 are in an unlocked (or a retracted) state, as illustrated in FIG. 33. When the linear actuator 3312 is in a second state (e.g., an extended state), the drive link bar 3314 is in a second position that causes the latch link bars 3316 to be in respective second positions such that the respective latches 3300 are in a locked (or an extended) state, as illustrated in FIG. 34.

A lateral calibration laser 3320 can be included to calibrate the position of the moveable assembly 2553 relative to the second axis 102 during setup. FIGS. 33 and 34 also illustrate the cylinders 3118 for the compliant connections 3110.

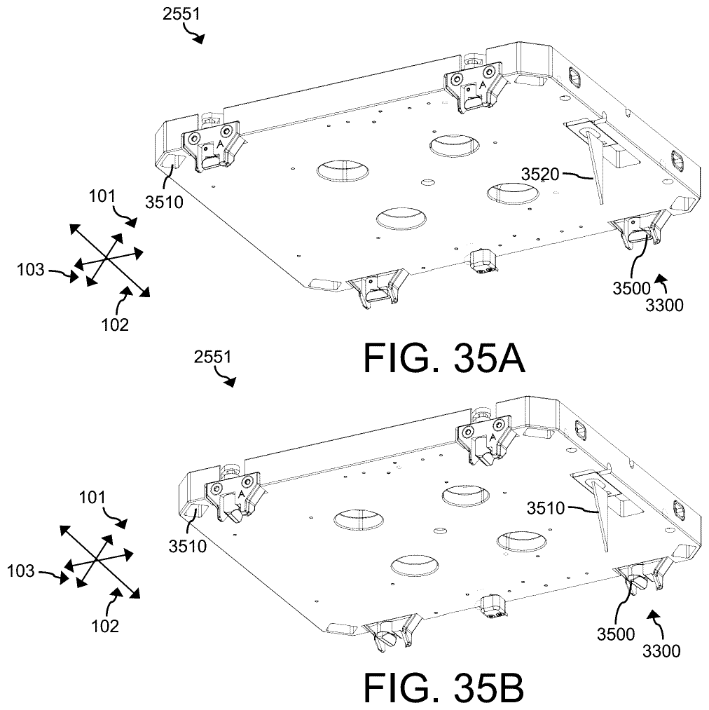

FIGS. 35A and 35B are lower isometric views of the lower assembly 2551 where the latches 3300 are in the unlocked and locked states, respectively, according to an embodiment. In the locked state, a projection 3500 of each latch 3300 is rotationally oriented such that the projection 3550 extends inwardly and orthogonally to the side of the lower assembly 2551 to which the latch 3300 is attached. Each projection 3500 is oriented parallel to the second axis 102 in the locked state. In the unlocked state, the projection 3500 is rotationally offset by 90 degrees compared to when the latch 3300 is in locked state such that the projection 3500 extends parallel to the side of the lower assembly 2551 to which the latch 3300 is attached. Each projection 3500 is oriented parallel to the first axis 102 in the unlocked state.

In the locked state, the latches 3300 (e.g., projections 3500) are configured to mechanically engage corresponding cutouts or apertures 3510 defined in the battery 435 to hold the battery 435, for example as illustrated in FIG. 29, for example to transport a battery 435 between a cubby 300 and a tray bay 300 (in either direction). In the unlocked state, the latches 3300 (e.g., projections 3500) are configured to mechanically disengage the corresponding cutouts or apertures 3510 defined in the battery 435 to release the battery 435, for example into a cubby 300 or onto a tray bay 310.

One or more battery detection sensors 3510 can be disposed on the underside of lower assembly 2551 to detect the presence or absence of a battery 435. Each battery detection sensor(s) 3510 can include a physical switch, an optical sensor, an inductive sensor, and/or another sensor. The output of the battery detection sensors 3510 can be used as feedback for a controller.

A vertical calibration laser 3520 can be included to calibrate the position of the moveable assembly 2553 relative to the third axis 102 during setup.

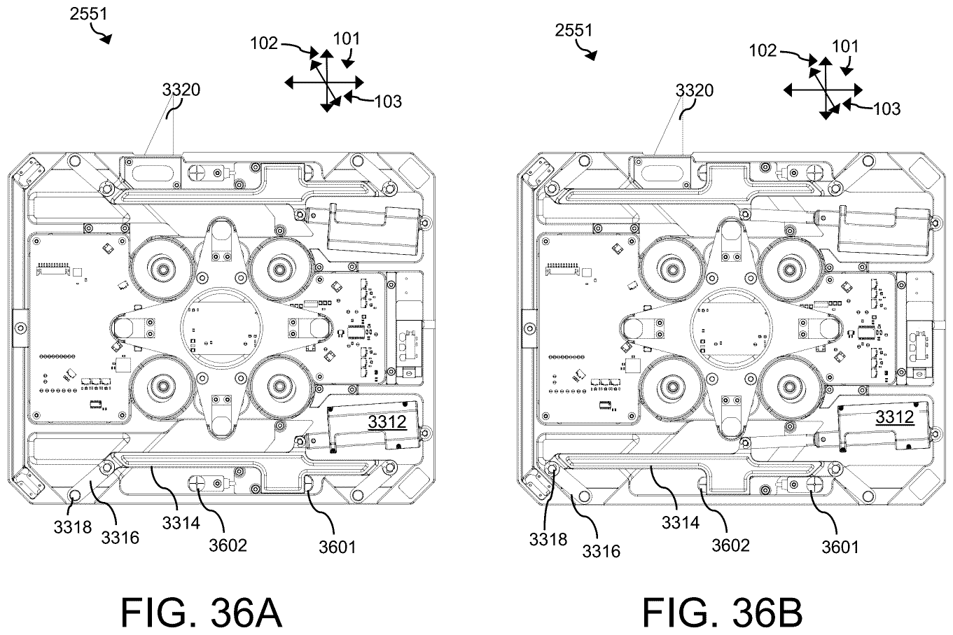

FIGS. 36A and 36B are top views of the lower assembly 2551 where the latches 3300 are in the unlocked and locked states, respectively, according to an embodiment. In the unlocked state, the drive link bar 3314 is configured to mechanically and/or electrically engage a first limit switch 3601. In the locked state, the drive link bar 3314 is configured to mechanically and/or electrically engage a second limit switch 3602. The first and second limit switches 3601, 3602 can be used as feedback by a controller to confirm and/or determine the state of the latches 3300.

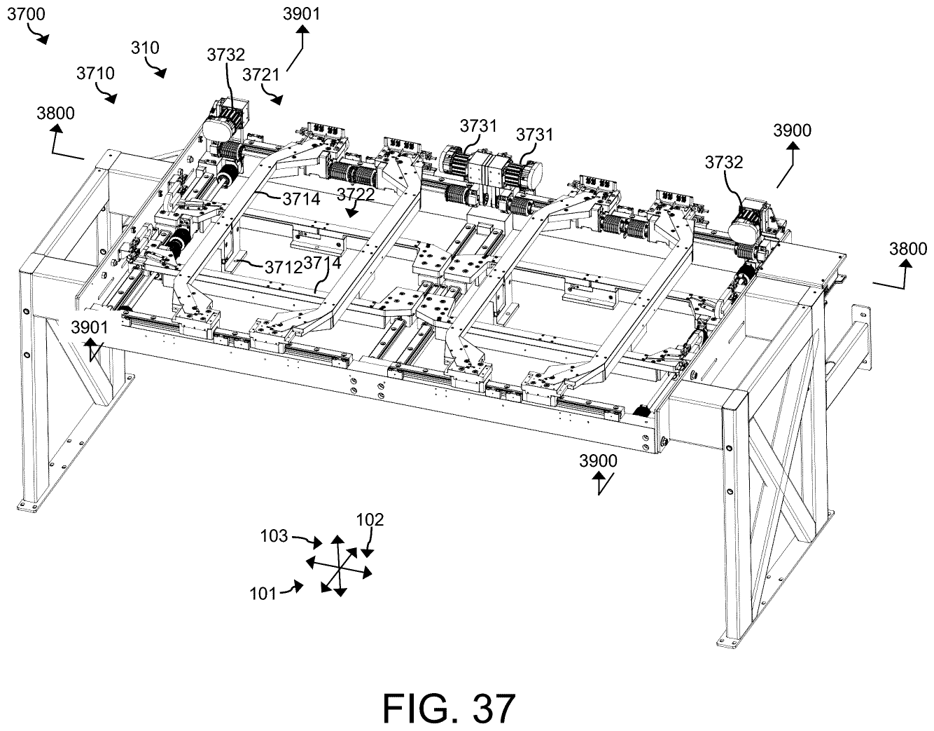

FIG. 37 is an isometric view of a tray bay assembly 3700 according to an embodiment. The tray bay assembly 3700 includes first and second tray bays 310. Each tray bay 310 has a respective tray-bay drive assembly 3710.

Each tray-bay drive assembly 3710 is configured to drive a plurality of ledges 3712 inwardly or outwardly to hold or release a battery tray 360. The tray-bay drive assembly 3710 can be controlled by a controller such as controller 230.

The tray-bay drive assembly 3710 includes first and second pairs (or sets) 3721, 3722 of moveable arms 3714. The first set 3721 is driven by a first motor 3731 parallel to the second axis 102. The second set 3722 is driven by a second motor 3732 parallel to the first axis 101. The ledges 3712 attached to the first set 3721 of arms 3714 extend parallel to the first axis 101. The ledges 3712 attached to the second set 3722 of arms 3714 extend parallel to the second axis 102.

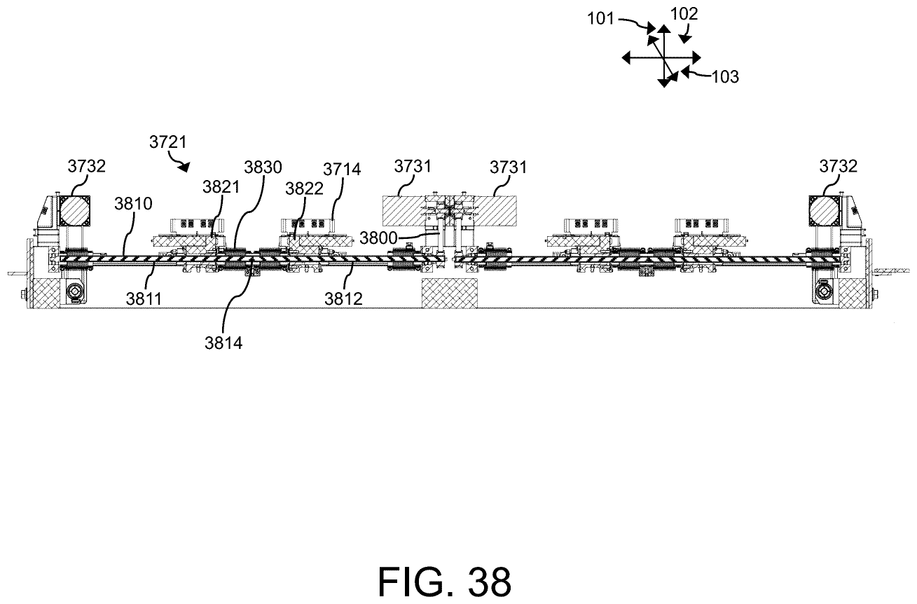

FIG. 38 is a cross section through plane 3800 in FIG. 37 according to an embodiment. The first motor 3731 is configured to drive a belt 3800 that is mechanically coupled to a lead screw 3810. The lead screw 3810 is double threaded. First threads 3811 on the lead screw 3810 are oriented in a first direction (e.g., a right-hand thread) and second threads 3812 on the lead screw 3810 are oriented in a second direction (e.g., a left-hand thread) that is opposite to the first direction. The first and second threads 3811, 3812 can be disposed symmetrically on the lead screw 3810 with respect to a middle 3814 of the lead screw 3810, which is between the first set 3721 of arms 3714. First and second nuts 3821, 3822 are mounted on the lead screw 3810 and are mechanically coupled to the respective arms 3714 of the first set 3721. The lead screw 3810 extends parallel to the second axis 102.

In operation, the first motor 3731 can rotate in a first direction which causes the belt 3800 and the lead screw 3810 to rotate in respective first directions. When the lead screw 3810 rotates in the first direction, the first and second nuts 3821, 3822 rotatingly engage the respective first and second threads 3811, 3812 which causes the first and second nuts 3821, 3822 to move in a first direction (e.g., outwardly) along the lead screw 3810. Moving the first and second nuts 3821, 3822 in the first direction causes the first set 3721 of arms 3714 to move in the first direction (e.g., outwardly with respect to the second axis 102). In addition, the first motor 3731 can rotate in a second direction which causes the belt 3800 and the lead screw 3810 to rotate in respective second directions. When the lead screw 3810 rotates in a second direction, the first and second nuts 3821, 3822 rotatingly engage the respective first and second threads 3811, 3812 which causes the first and second nuts 3821, 3822 to move in a second direction (e.g., inwardly) along the lead screw 3810. Moving the first and second nuts 3821, 3822 in the second direction causes the first set 3721 of arms 3714 to move in the second direction (e.g., inwardly with respect to the second axis 102). Thus, the first set 3721 of arms 3714 and the respective pair ledges 3712 attached thereto can be moved inwardly or outwardly together, with respect to the first axis 101, according to the direction of rotation of the first motor 3731.

A plurality of bellows 3830 can be disposed over the lead screw 3810 to protect the lead screw 3810 from dust, dirt, and/or other contaminants.

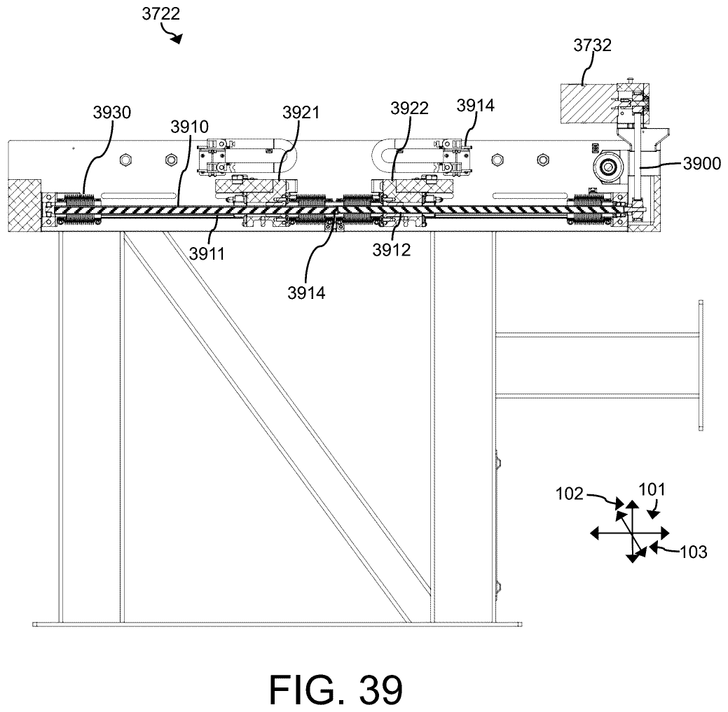

FIG. 39 is a cross section through plane 3900 in FIG. 37 according to an embodiment.

The second motor 3731 is configured to drive a belt 3900 that is mechanically coupled to a lead screw 3910. The lead screw 3910 is double threaded. First threads 3911 on the lead screw 3910 are oriented in a first direction (e.g., a right-hand thread) and second threads 3912 on the lead screw 3910 are oriented in a second direction (e.g., a left-hand thread) that is opposite to the first direction. The first and second threads 3911, 3912 can be disposed symmetrically on the lead screw 3910 with respect to a middle 3914 of the lead screw 3910, which is between the second set 3722 of arms 3714. First and second nuts 3921, 3922 are mounted on the lead screw 3910 and are mechanically coupled to the respective arms 3714 of the second set 3722. The lead screw 3910 extends parallel to the first axis 101.

In operation, the second motor 3732 can rotate in a first direction which causes the belt 3900 and the lead screw 3910 to rotate in respective first directions. When the lead screw 3910 rotates in the first direction, the first and second nuts 3921, 3922 rotatingly engage the respective first and second threads 3911, 3912 which causes the first and second nuts 3921, 3922 to move in a first direction (e.g., outwardly) along the lead screw 3910. Moving the first and second nuts 3921, 3922 in the first direction causes the second set 3721 of arms 3714 to move in the first direction (e.g., outwardly with respect to the first axis 101). In addition, the second motor 3732 can rotate in a second direction which causes the belt 3900 and the lead screw 3910 to rotate in respective second directions. When the lead screw 3910 rotates in a second direction, the first and second nuts 3921, 3922 rotatingly engage the respective first and second threads 3911, 3912 which causes the first and second nuts 3921, 3922 to move in a second direction (e.g., inwardly) along the lead screw 3910. Moving the first and second nuts 3921, 3922 in the second direction causes the second set 3722 of arms 3714 to move in the second direction (e.g., inwardly with respect to the first axis 101). Thus, the second set 3722 of arms 3714 and the respective pair ledges 3712 attached thereto can be moved inwardly or outwardly together, with respect to the first axis 101, according to the direction of rotation of the second motor 3732.

A plurality of bellows 3830 can be disposed over the lead screw 3910 to protect the lead screw 3910 from dust, dirt, and/or other contaminants.

A cross section through plane 3901 in FIG. 37 can be the same as the cross section through plane 3700 in FIG. 37 and thus is not illustrated for brevity.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A battery-storage apparatus comprising:
a plurality of cubbies having respective electrical ports;
a tray bay having an adjustable frame that releasably holds a battery tray; and
a robotic crane that automatically transports batteries between the battery tray and respective cubbies to charge and/or discharge the batteries using the respective electrical ports.

2. The battery-storage apparatus of claim 1, wherein each cubby includes a floor, sidewalls, a rear wall, a ceiling, and an open end.

3. The battery-storage apparatus of claim 2, wherein the open end of each cubby is aligned with respect to a first axis.

4. The battery-storage apparatus of claim 2, wherein a respective printed circuit board (PCB) is mounted on a surface of each cubby, each electrical port mounted on the respective PCB.

5. The battery-storage apparatus of claim 4, wherein each PCB includes one or more alignment pins.

6. The battery-storage apparatus of claim 4, wherein:
a respective support frame is attached to the surface of each cubby, each PCB mounted on the respective support frame, and
the respective support frame includes flexible spirals that allow the respective PCB to translate parallel to the surface of each cubby.

7. The battery-storage apparatus of claim 1, wherein the tray bay includes a frame that is defined, at least in part, by a pair of robotic arms, the robotic arms configured to move inwardly to hold the battery tray and to move outward to release the battery tray.

8. The battery-storage apparatus of claim 1, wherein the crane includes:
a shaft that extends along a vertical axis;
a base attached to the shaft;
a telescoping arm attached to the base; and
robotic grippers attached to the telescoping arm, the robotic grippers configured to releasably hold an individual battery.

9. The battery-storage apparatus of claim 8, wherein the base is electromechanically attached to the shaft such that a height of the base is adjustable.

10. The battery-storage apparatus of claim 9, wherein:
the telescoping arm is configured to extend and retract with respect to a first axis, and
an open end of each cubby is aligned with respect to the first axis.

11. The battery-storage apparatus of claim 10, wherein the robotic grippers includes fingers having planar surfaces to mechanically engage the individual battery.

12. The battery-storage apparatus of claim 10, wherein:
a first set of the fingers is mechanically attached to a first robotic arm,
a second set of the fingers is mechanically attached to a second robotic arm,
the first and second robotic arms are configured to move inwardly such that the first and second set of fingers mechanically engage first and second sides, respectively, of the individual battery, and
the first and second robotic arms are configured to move outwardly such that the first and second set of fingers release the first and second sides, respectively, of the individual battery.

13. The battery-storage apparatus of claim 10, further comprising one or more tracks that extend parallel to a second axis that is orthogonal to the first and vertical axes, wherein the shaft is mounted on the one or more tracks to adjust a position of the shaft with respect to the second axis.

14. The battery-storage apparatus of claim 13, wherein a battery-exchange robot channel is defined below the tray bay, the battery-exchange robot channel configured to receive rails on which a battery-exchange robot is mounted.

15. A battery-storage apparatus comprising:
a plurality of cubbies having respective electrical ports;
a plurality of tray bays, each tray bay having a respective adjustable frame configured to releasably hold a respective battery tray, each battery tray holding one or more batteries; and
a plurality of robotic cranes, each robotic crane configured to transport the battery(ies) between the respective battery tray and respective cubbies to charge and/or discharge the batteries using the respective electrical ports.

16. The battery-storage apparatus of claim 15, wherein each crane includes:
a shaft that extends parallel to a vertical axis;
a base electromechanically attached to the shaft such that a height of the base is adjustable;
a telescoping arm attached to the base; and
robotic grippers attached to the telescoping arm, the robotic grippers including fingers having planar surfaces to releasably hold an individual battery.

17. The battery-storage apparatus of claim 16, wherein for each crane:
the telescoping arm is configured to extend and retract with respect to a first axis, and
an open end of each cubby is aligned with respect to the first axis.

18. The battery-storage apparatus of claim 17, wherein for each crane:
a first set of the fingers is mechanically attached to a first robotic arm,
a second set of the fingers is mechanically attached to a second robotic arm,
the first and second robotic arms are configured to move inwardly such that the first and second set of fingers mechanically engage first and second sides, respectively, of the individual battery, and
the first and second robotic arms are configured to move outwardly such that the first and second set of fingers release the first and second sides, respectively, of the individual battery.

19. The battery-storage apparatus of claim 18, further comprising one or more common tracks that extend parallel to a second axis that is orthogonal to the first and vertical axes, wherein a respective shaft of each crane is mounted on the one or more common tracks to adjust a position of the respective shaft with respect to the second axis.

20. A battery-exchange system comprising:
a battery-exchange robot configured to transport a battery tray between an electric vehicle and a battery-storage apparatus, wherein the battery-storage apparatus comprises:
a plurality of cubbies having respective electrical ports;
a tray bay having an adjustable frame that releasably holds the battery tray, wherein a battery-exchange robot channel is defined below the tray bay; and
a robotic crane that transports batteries between the battery tray and respective cubbies to charge and/or discharge the batteries using the respective electrical ports.
